(19) United States
(12) Patent Application Publication
(10) Pub. No.: US 2025/0380039 A1
(43) Pub. Date: Dec. 11, 2025

(54) GENERATING BRANCHING CANDIDATE VIDEO ELEMENTS

(71) Applicant: Spotter, Inc., Culver City, CA (US)

(72) Inventors: Paul S. Bakaus, San Francisco, CA (US); Robert L. Gabel, Los Gatos, CA (US); Andrea Kuhnertova, Los Angeles, CA (US)

(21) Appl. No.: 18/939,338

(22) Filed: Nov. 6, 2024

Related U.S. Application Data
(60) Provisional application No. 63/658,736, filed on Jun. 11, 2024.

(51) Int. Cl. H04N 21/8541; H04N 21/431; H04N 21/84

(52) U.S. Cl. CPC H04N 21/8541; H04N 21/4318; H04N 21/84

(57) ABSTRACT

Generating branching candidate video elements is disclosed, including: obtaining a first set of candidate video elements from a model by prompting the model using a first prompt including at least base data, a first modifying action, and video creator-specific information; causing the base data and the first set of candidate video elements to be presented with first branching relationships at a user interface; receiving, via the user interface, a selected candidate video element from the first set of candidate video elements and a second modifying action; obtaining a second set of candidate video elements from the model by prompting the model using a second prompt including at least the selected candidate video element, the second modifying action, and the video creator-specific information; and causing the selected candidate video element and the second set of candidate video elements to be presented with second branching relationships at the user interface.

### CROSS REFERENCE TO OTHER APPLICATIONS

This application claims priority to U.S. Provisional Patent Application No. 63/658,736 entitled GENERATING BRANCHING CANDIDATE VIDEO ELEMENTS filed Jun. 11, 2024 which is incorporated herein by reference for all purposes.

### BACKGROUND OF THE INVENTION

In response to similar prompts, machine learning models are configured to generate precise output but not necessarily creative output. Conventional general large language models (LLMs) are typically trained to generate output consistently in response to the same or similar input. This is due to the training data comprising of questions and expected answer pairings. As a result, a conventional LLM will interpolate from the training data in a predictable way. However, it would be desirable to leverage a machine learning model to iteratively generate creative output but in a constrained manner in response to user feedback.

### BRIEF DESCRIPTION OF THE DRAWINGS

Various embodiments of the invention are disclosed in the following detailed description and the accompanying drawings.

FIG. 1 is a diagram showing an embodiment of a system for generating branching candidate video elements.

FIG. 2 is a diagram showing an example candidate video element branching system in accordance with some embodiments.

FIG. 3 is a flow diagram showing an embodiment of a process for generating branching candidate video elements in accordance with some embodiments.

FIG. 4 is a flow diagram showing an example of a process for deriving a set of video summaries corresponding to a video creator's representative videos in accordance with some embodiments.

FIG. 5 is a flow diagram showing an example of a process for generating candidate video elements corresponding to a single, selected video element type in accordance with some embodiments.

FIG. 6 is a flow diagram showing an example of a process for generating candidate video titles in accordance with some embodiments.

FIG. 7 is a diagram showing a first example user interface associated with generating branching sets of candidate video titles in accordance with some embodiments.

FIG. 8 is a diagram showing a second example user interface associated with generating branching sets of candidate video titles in accordance with some embodiments.

FIG. 9 is a diagram showing a third example user interface associated with generating branching sets of candidate video titles in accordance with some embodiments.

FIG. 10 is a diagram showing a fourth example user interface associated with generating branching sets of candidate video titles in accordance with some embodiments.

FIG. 11 is a diagram showing a fifth example user interface associated with generating branching sets of candidate video titles in accordance with some embodiments.

FIG. 12 is a flow diagram showing an example of a process for generating candidate video thumbnail images in accordance with some embodiments.

FIG. 13 is a diagram showing an example data structure including hierarchical data corresponding to a series of iterations of candidate video elements that are generated from base data in accordance with some embodiments.

FIG. 14 is a flow diagram showing an example of a process for restoring a saved session in accordance with some embodiments.

FIG. 15A and 15B are diagrams that represent three different branching trees of candidate video elements.

FIG. 16 is a flow diagram showing an example of a process for generating candidate video elements corresponding to a plurality of video element types in accordance with some embodiments.

FIGS. 17A and 17B show example user interfaces associated with multiple video element type candidate generation in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of generating branching candidate video elements are described herein. A first set of candidate video elements output from a machine learning model is obtained by prompting the model using a first prompt including at least base data, a first modifying action, and video creator-specific information. In various embodiments, a “video creator” is an entity comprising one or more individuals that produce video content. For example, the video creator user may have previously produced and recorded a set of videos that is shared with audiences at a video streaming platform. In various embodiments, the “candidate video elements” that are output by a model correspond to a requested “video element type.” In various embodiments, the “video element type” comprises a type of element that is used in the development and/or the representation of a new video that is to be created by the video creator user. Examples of video element types include a video title, a thumbnail image to represent a video (e.g., and one that will be presented at a video streaming platform), a video concept (e.g., a description of the synopsis of the video), a video scene (e.g., an introductory scene, a climatic scene, a visual spectacle scene, a conclusion scene), a joke in a video, a primary plot in a video, a secondary plot in a video, a twist in a video, a story hook in a video, and a prank to show in a video. In various embodiments, the “first set of candidate video elements” is generated in response to a video creator user's request (or a request made on behalf of the video creator user) for candidate video elements of a requested video element type in addition to base data and a first modifying action. In various embodiments, the “base data” is an initial user submitted or a programmatically generated video element of the requested type to use as a reference upon which an initial/first set of candidate video elements is to be generated. In various embodiments, the “first modifying action” comprises a modification to be applied to the base data and can either be selected among enumerated “static actions” or dynamically input by a user as a “user interactive action” at a user interface. In various embodiments, the “video creator-specific information” comprises data that is derived from historical videos that have been created/uploaded by the particular creator. For example, the video creator-specific information can be text-based summaries or text-based loglines that are derived from text transcriptions of a set of representative historical videos that have been created/uploaded by the particular creator. The combination of at least the base data, the first modifying action, and the video creator-specific information were included in a text-based first prompt to a machine learning model corresponding to the requested video element type. As such, the “first set of candidate video elements” comprises one or more candidate video elements that are candidates of video elements of the requested type that are generated by the model in part by modifying the base input data according to the first modifying action and in the style of the video creator-specific information. A first presentation is presented at a user interface, in which the first set of candidate video appears to branch out from the base input data based on the first modifying action.

A selection of a candidate video element from the first set of candidate video elements and a second modifying action are received via the user interface. A second set of candidate video elements output from the model is obtained by prompting the machine learning model using a second prompt including at least the selected candidate video element, a second modifying action, and video creator-specific information. Similar to the first modifying action, the “second modifying action” comprises a modification to be applied to the selected candidate video element and can either be selected among enumerated “static actions” or dynamically input by a user as a “user interactive action” at a user interface. The combination of at least the selected candidate video element, the second modifying action, and the video creator-specific information was included in a text-based second prompt to the machine learning model corresponding to the requested video element type. As such the “second set of candidate video elements” comprises one or more candidate video elements that are candidates of video elements of the requested type that are generated by the model in part by modifying the candidate video element selected from the first set of candidate video elements according to the second modifying action and constrained by the historical attributes of the video creator-specific information. A second presentation is caused to be presented at the user interface, in which the second set of candidate video elements branches out from the selected candidate video element based on the second modifying action. In some embodiments, a candidate video element may then be selected among the second set of candidate video elements along with a third modifying action to cause a third set of candidate video elements to be generated and presented in a manner that appears to branch out from the candidate video element selected from the second set, and so forth, until the user stops iterating upon previously generated candidate video elements.

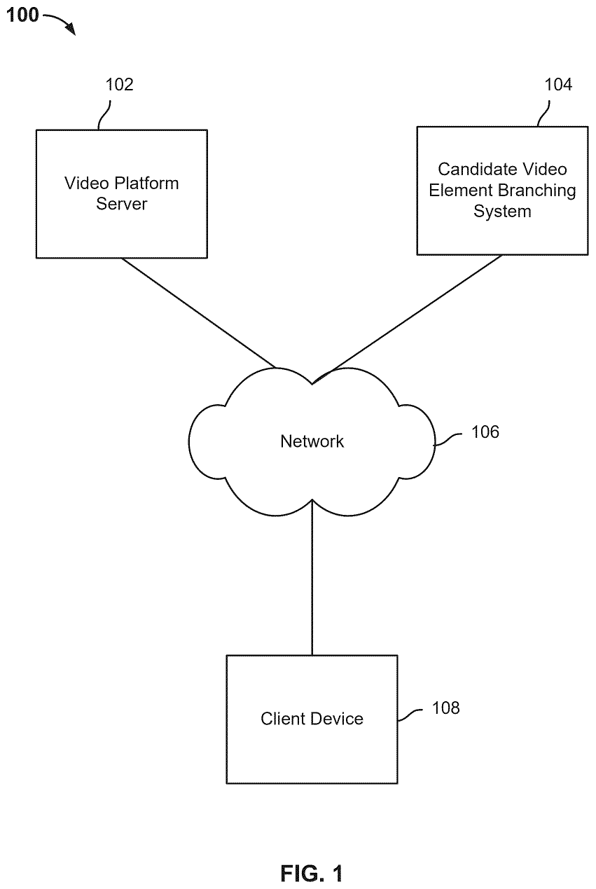

FIG. 1 is a diagram showing an embodiment of a system for generating branching candidate video elements. As shown in FIG. 1, system 100 includes video platform server 102, candidate video element branching system 104, network 106, and client device 108. Network 106 can be implemented using one or more data and/or telecommunications networks. Video platform server 102, candidate video element branching system 104, and client device 108 can communicate to each other over network 106.

Video platform server 102 is configured to host videos on its online video sharing platform. In various embodiments, video platform server 102 is configured to store the underlying files associated with a video that is uploaded by a video creator user, as well as track (relatively) static video metadata such as, for example, the identity of the video creator user, tags/keywords associated with the video, the thumbnail image that is used to represent the video, the title of the video, and the upload date of each video. For example, the static metadata associated with a video may be uploaded by the respective video creator user to video platform server 102. As mentioned above, a “video creator” comprises one or more individuals that develop and produce videos that are shared on video platform server 102. For example, a video creator may include the same or different individuals that produce videos and/or appear in the videos. In the example of the platform comprising an online video hosting platform, videos may be organized into “channels,” where a channel is associated with one or more videos and a video creator may be associated with one or more channels of videos. In the example of the platform comprising an online video hosting platform, platform server 102 is also configured to capture information associated with users that interact with the videos. In various embodiments, video platform server 102 is also configured to track dynamic video metadata such as user interaction with the videos. For example, dynamic metadata associated with a video may be monitored and maintained by video platform server 102 over time. Examples of such dynamic metadata include the view count of a video (e.g., the number of the times that the video has been viewed), the timestamps of the views of the video, the number of subscribers to a video creator user/video channel associated with a video, the comments that users have made on the video, and/or the number of likes that users have indicated on the video. In various embodiments, platform server 102 is configured to assign a user identifier (ID) to each user (e.g., an “audience member”) that interacts with a video. In various embodiments, a user ID comprises an anonymized string that uniquely represents an individual.

Candidate video element branching system 104 is configured to iteratively generate sets of candidate video elements corresponding to one or more video element types in response to user selections. As mentioned above, examples of video element types include: a video title, a thumbnail image to represent a video (e.g., and one that will be presented at a video streaming platform), a video concept (e.g., a description of the synopsis of the video), a video scene (e.g., an introductory scene, a climatic scene, a visual spectacle scene, a conclusion scene), a joke in a video, a primary plot in a video, a secondary plot in a video, a twist in a video, a story hook in a video, and a prank to show in a video. In various embodiments, candidate video element branching system 104 is configured to use machine learning model(s) to generate the sets of candidate video elements that are constrained by the profile data of a specified video creator. In various embodiments, the “profile data” of a specified video creator comprises description data of the creator and/or information/attributes derived from historical videos that the video creator had uploaded to video platform server 102. For example, the profile data can be text-based summaries or text-based loglines that are derived from text transcriptions of a set of representative historical videos that have been created/uploaded by the particular creator to video platform server 102.

In some embodiments, candidate video element branching system 104 is configured to iteratively generate sets of candidate video elements corresponding to a selected, single video element type for a specified video creator. In some embodiments, a request to generate iterative sets of candidate video elements corresponding to a selected, single video element type is received from client device 108. Examples of client device 108 include a mobile device or any computing device. In some embodiments, to initiate the generation of sets of candidate video elements corresponding to a selected, single video element type, a user may optionally submit base data comprising an initial example of a video element corresponding to the selected video element type. For example, where the video element type is a video title, the base data can be a working title (e.g., a draft of a video title that is to be used as reference to generate additional candidate titles). In some embodiments, to initiate the generation of sets of candidate video elements corresponding to a selected, single video element type, candidate video element branching system 104 is configured to programmatically generate base data. For example, candidate video element branching system 104 can generate the base data corresponding to the specified video creator by prompting a machine learning model corresponding to the selected, single video element type for a random video element of that type constrained by (e.g., in the style of) the profile data of the specified video creator. Once the base data corresponding to the selected, single video element type for the specified video creator is obtained, candidate video element branching system 104 is configured to receive a user selected first modifying action to be performed on the base data via a user interface that is presented at client device 108. In some embodiments, a “modifying action” that candidate video elements are to be generated in part based on includes “static actions” and “user interactive actions.” Examples of static actions for a text-based video element type may include rephrase, shorten, reverb, and explode. Examples of static actions for an image-based video element type (e.g., thumbnail images) may include “change from close-up to wide-angle shot,” “change from style from subtle to extreme,” and “change the angle to overhead.” In some embodiments, static actions may be enumerated (e.g., and presented as options for selection) at the user interface that is presented at client device 108 and a user interactive action may be input by a user at the user interface that is presented at client device 108 (as an alternative to the presented, static modifying actions). After the selection of input of a first modifying action, candidate video element branching system 104 is configured to generate an initial prompt to a machine learning model that corresponds to the selected video element type to obtain a first/initial set of candidate video elements corresponding to the selected video element type. In various embodiments, the initial prompt includes at least the base data, the first modifying action, and the video creator-specific profile data. In some embodiments, if the requested video element type were text-based (e.g., a video title or a video concept), then the machine learning model would have been a large language model (LLM) (e.g., ChatGPT®, Meta Llama®). Where the model comprises a LLM, the LLM is prompted based on the text-based first prompt and then the LLM would generate the first set of text-based candidate video elements. In some embodiments, if the requested video element/initial type were an image-based (e.g., a thumbnail image) request, then the machine learning model would have been a text-to-image model or a LLM in series with a text-to-image model (e.g., Stable Diffusion®). Where the model comprises a LLM and a text-to-image model, the LLM is prompted based on the text-based first prompt and the output of the LLM is then fed as a prompt into a text-to-image model to output the first set of image-based candidate video elements. As such, the “first set of candidate video elements” comprises one or more candidate video elements that are candidates of video elements of the requested type that are generated by the model in part by modifying the base data according to the first modifying action and constrained by the provided profile data of the video creator-specific information. A first presentation is presented at the user interface of client device 108, in which the first/initial set of candidate video is shown to branch out from the base data based on the first modifying action.

After the first presentation, candidate video element branching system 104 is configured to receive a user selection of a candidate video element from the first set of candidate video elements and a second modifying action are received via the user interface that is presented at client device 108. Along with the user selection of the candidate video element from the first set, candidate video element branching system 104 is configured to receive a second modifying action comprising a modification to be applied to the selected candidate video element. As described above, the second modifying action may be either an enumerated static modifying action or a dynamically input by a user as a user interactive action. In various embodiments, candidate video element branching system 104 is configured to generate a subsequent prompt to the machine learning model that corresponds to the selected video element type to obtain a second set of candidate video elements corresponding to the selected video element type. In various embodiments, the second prompt includes at least the selected candidate video element, the second modifying action, the video creator-specific profile data. As such the “second set of candidate video elements” comprises one or more candidate video elements that are candidates of video elements of the requested type that are generated by the model in part by modifying the candidate video element selected from the first set of candidate video elements according to the second modifying action and constrained by the provided profile data of the video creator-specific information. A second presentation is presented at the user interface of client device 108, in which the second set of candidate video elements branches out from the selected candidate video element based on the second modifying action. A candidate video element may then be selected among the second set of candidate video elements along with a third modifying action to cause a third candidate set of video elements to be generated and presented in a manner that appears to branch out from the candidate video element selected from the second set, similar to what is described above, and so forth, until the user stops iterating upon previously generated candidate video elements. In some embodiments, candidate video element branching system 104 is configured to receive a user selection of a candidate video element from the second set of candidate video elements and a third modifying action are received via the user interface of client device 108 to cause a third candidate set of video elements to be generated, in a manner similar to what is described above, and presented in a manner shown to branch out from the candidate video element selected from the second set, and so forth, until a stop criterion is reached. An example of a stop criterion is the user indicating at the user interface to no longer iterate upon previously generated candidate video elements.

In various embodiments, candidate video element branching system 104 is configured to store a data structure comprising hierarchical data (e.g., a tree-based data structure that describes, at least, the branching relationships among the base data, the first set of candidate video elements, the second set of candidate video elements, and the selected candidate video elements thereof) corresponding to each instance of a candidate video element generation corresponding to a selected video element type at a database. For example, in this data structure, the base data may comprise a node in a higher-level layer (e.g., the root) of the tree and each subsequent set of candidate video elements that is generated/iterated from a selected node/candidate video element from a previous, higher layer are represented as nodes in a subsequent, lower layer in the tree. In some embodiments, the series of nodes comprising the candidate video elements that are selected from each subsequent layer/set of candidates in the tree is referred to as the selected “path” within the tree.

In some embodiments, candidate video element branching system 104 is configured to iteratively generate sets of candidate video elements corresponding to two or more video element types for a specified video creator. The iterative generation of branching candidate video elements corresponding to two or more video element types is sometimes referred to as “multi-modal” generation. In some embodiments, a request to generate iterative multi-modal sets of candidate video elements is received from client device 108. As will be described in further detail below, during multi-modal candidate video elements generation, candidate video element branching system 104 is configured to enable the switching of respective candidate video elements generation/branching among two or more video element types such that the subsequent candidate video element of a currently selected video element is at least constrained by the previously selected/pinned candidate video element(s) of the other video element type(s).

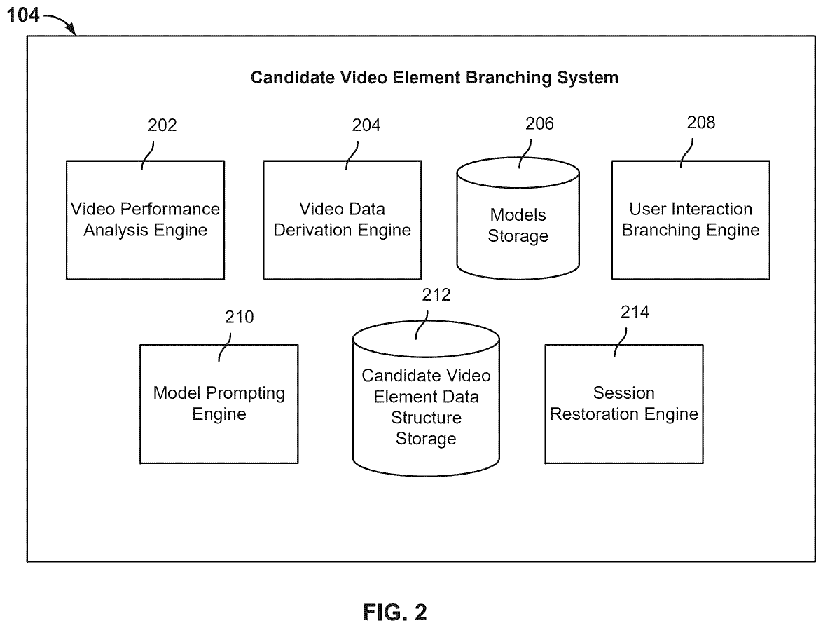

FIG. 2 is a diagram showing an example candidate video element branching system in accordance with some embodiments. In some embodiments, candidate video element branching system 104 of FIG. 1 may be implemented using the example of FIG. 2. In the example of FIG. 2, the candidate video element branching system includes video performance analysis engine 202, video data derivation engine 204, models storage 206, user interaction branching engine 208, model prompting engine 210, candidate video element data structure storage 212, and session restoration engine 214. Each of video performance analysis engine 202, video data derivation engine 204, models storage 206, user interaction branching engine 208, model prompting engine 210, candidate video element data structure storage 212, and session restoration engine 214 may be implemented using hardware (e.g., one or more processors and one or more memories) or software.

Video performance analysis engine 202 is configured to determine the performance metrics of videos based on dynamic metadata that is obtained from a video platform server. In various embodiments, the performance metrics of videos are determined for a set of videos that are grouped together (e.g., by their video creators). In some embodiments, video performance analysis engine 202 is configured to query a video platform server (e.g., video platform server 102 of FIG. 1) for a time series of audience interaction metrics per each interval of time of each video from a set of videos (e.g., videos that have been created by a specified video creator user). For example, the time series of audience interaction metrics of a video comprises the respective view counts of a video per each day within a given window of time (e.g., the period between the upload date of the video to the video platform server and the following seven or some other predetermined number of days). Video performance analysis engine 202 is configured to determine the aggregate audience interaction metric of each video in the set of videos across their given windows of time and then determine the average aggregate audience interaction metric for all the videos in the set. Then, video performance analysis engine 202 is configured to determine the subset of videos of the set whose respective aggregate audience interaction metric exceeds the average aggregate audience interaction metric. This subset of videos whose aggregate audience interaction metrics exceed the average aggregate audience interaction metrics are determined to be meeting the criterion for being identified as “overperforming” videos from the set. For example, the videos of a certain set (e.g., the body of videos that are uploaded by the same video creator to the video platform server) whose aggregate view counts during the first week of its upload to the platform exceed the average view count of that set's videos during their respective first weeks are determined to be “overperforming.” “Overperforming” videos can be assumed to be more popular and/or sensational and potentially, more desirable to service as references for new videos to be created. A first example use of identifying “overperforming” videos from a particular set of videos (e.g., belonging to a specified video creator user and/or that have been viewed by a particular video creator user's audience members) is to identify a subset of videos to include as representative data of a video creator's style in a prompt to a model that is configured to generate candidate video elements. As will be described in further detail below, in some embodiments, prompts to a model to generate candidate video elements include text-based summaries (“loglines” of the text transcription of a video creator's selected subset of videos) that are to constrain the scope, style, and/or content, for example, of the candidate video elements to be generated. A second example use of identifying “overperforming” videos of a particular video creator user is to identify a subset of that creator's videos to use to derive training data from to train a video creator user-specific model.

Video data derivation engine 204 is configured to generate representative data from video data obtained from a video platform server. The representative data that is derived from historical video data obtained from a video platform server can be used for various applications. In a first example application, the derived representative video data can be used to serve as training data to train models such as video creator user-specific models and/or video element type-specific models. In a second example application, the derived representative video data can be determined from selected (e.g., overperforming) videos in response to a request for candidate video elements and as such, the derived representative video data can be included in at least a portion of a video creator's profile data for constraining the style, scope, and/or content of the candidate video elements that are to be generated, as will be further described below.

In some embodiments, video data derivation engine 204 is configured to derive summaries (which are sometimes referred to as “loglines”) of videos. In some embodiments, a model that has been trained on text transcriptions video (e.g., movie, televisions shows) and their corresponding published (e.g., human written) loglines are obtained. In some embodiments, video data derivation engine 204 is configured to obtain video data (e.g., video files and audio files) of an identified set of videos (e.g., the overperforming videos of a specified video creator) from a video platform server and then generate a text transcription of each such video. Then, video data derivation engine 204 is configured to input the text transcription of a video into this logline model to obtain a logline corresponding to the video.

Models storage 206 is configured to store the parameters (e.g., weights) of the models that have been trained with at least the training data that is generated, at least in part, by video data derivation engine 204. For example, models storage 206 is configured to store parameters of video creator-specific models and video element type-specific models (e.g., beat sheet model(s), thumbnail image model(s), and video title model(s)). In some embodiments, each video creator-specific model is trained on the creator's biographic data (e.g., the video creator provided description of themselves) and/or the data derived from the creator's videos that were uploaded to the video platform server. In some embodiments, each video element type-specific model has been trained on video elements that have been historically submitted and/or derived from videos submitted by various video creators at the video platform server. In various embodiments, models storage 206 is further configured to store one or more predetermined prompt template(s) that have been determined for each particular model. As will be described below, when a prompt is being generated for a particular model (e.g., to generate a new set of candidate video elements), a corresponding predetermined prompt template for that model is retrieved from storage and then its placeholder values are replaced with the constraints/parameters of that particular prompt.

User interaction branching engine 208 is configured to receive a request to generate candidate video elements corresponding to a specified video creator from a user interface. In some embodiments, user interaction branching engine 208 is configured to generate candidate video elements corresponding to a single video element type (in “single mode” operation) or to simultaneously generate multiple video element types (in “multi-modal” operation) associated with a single project. For example, a user may request to receive candidate video elements corresponding to a single video element type when the user seeks assistance with ideating one task/aspect in the process of producing a new video to be uploaded to the video platform server. In the event that the request is for a single specified video element type, then user interaction branching engine 208 is configured to obtain base data that serves as an initial value for the specified video element type. In some embodiments, user interaction branching engine 208 is configured to obtain the base data from the user via the user interface. In some embodiments, user interaction branching engine 208 is configured to obtain the base data by prompting a model that has been trained to generate video elements of the specified video element style/task to generate a random video element. User interaction branching engine 208 is configured to present the base data corresponding to the specified single video element type at the user interface and prompt the user to select an initial/first modifying action to be performed on the base data to generate the initial/first set of candidate video elements. In some embodiments, user interaction branching engine 208 is configured to present a set of enumerated/predetermined static modifying actions at the user interface from which the user is to select one thereof. Examples of static modifying actions for a text-based video element type may include rephrase, shorten, reverb, and explode. Examples of static modifying actions for an image-based video element type (e.g., thumbnail images) may include “change from close-up to wide-angle shot,” “change style from subtle to extreme,” and “change the angle to overhead.” In addition to the static modifying actions, user interaction branching engine 208 is configured to present an option (e.g., an input window) for the user to dynamically enter a text-based user interactive modifying action.

In response to either of the user's selection of a static modifying action or the user's submission of an input user interactive modifying action, user interaction branching engine 208 is configured to request model prompting engine 210 to generate a first prompt to a corresponding machine learning model corresponding to the specified, single video element type based on the received, initial/first modifying action. In some embodiments, the first prompt was generated by model prompting engine 210 based at least in part on the base data, an optionally received user provided description input that further describes the base data, the obtained initial/first modifying action, and video creator-specific information (which is sometimes referred to as “profile data”) associated with the user for which candidate video elements were being generated. In various embodiments, model prompt engine 210 receives constraints/values that are received from user interaction branching engine 208 (e.g., base data, modifying actions, selected candidate video element from which to iterate, video creator specific profile data) and then generates a prompt by inserting the values into appropriate locations within a predetermined template that corresponds to the type of machine learning models for which the candidate video elements are requested. For example, a template includes the specific instructions to a text-to-text or text-to-image model that would cause the model to generate a new set of candidate video elements in accordance with the provided constraints. In some embodiments, the profile data associated with the current video creator comprises the summaries or loglines that are generated from the text transcriptions of a representative set of videos that had been previously generated/uploaded by the user to a video platform. In some embodiments, the profile data associated with the current video creator comprises a text-based description of the likeness of the video creator. In some embodiments, if the requested video element type were text-based (e.g., a video title or a video concept), then the machine learning model would be a large language model (LLM) (e.g., ChatGPT®, Meta Llama®). Where the model comprises a LLM, the LLM is prompted by model prompting engine 210 based on the text-based first prompt and then the LLM would generate the first set of text-based candidate video elements. In a first example, the LLM comprises a base, third-party LLM whose output is steered based on the prompt. In a second example, the LLM that is to be prompted using the generated prompt comprises a video element type-specific model (e.g., a language model that has been trained on historical instances of video elements that have been uploaded to the video platform server to generate output in the format) of the requested type of video element. In some embodiments, if the requested video element type were an image-based (e.g., a thumbnail image), then the machine learning model would have been a text-to-image model or a LLM in series with a text-to-image model (e.g., a diffusion model such as Stable Diffusion®). For example, the text-to-image model has already been trained on images in the style of the video element type (e.g., thumbnail images of videos that have been historically uploaded to the video platform server). Where the model comprises a LLM (e.g., a Contrastive Language-Image Pre-training (CLIP) model) in series with a text-to-image model, the LLM is first prompted by model prompting engine 210 based on the text-based first prompt and the output of the LLM is then fed as a prompt into a text-to-image model to output the first set of image-based candidate video elements. In some embodiments, if the requested video element type were an image-based, an additional plugin (e.g., a Low-Rank Adaptation (LoRA)) that has been customized to steer a text-to-image model to generate images in the likeness of the video creator is obtained and this plugin is used on top of the text-to-image model to ensure that the generated candidate image-based video elements include accurate likenesses to the video creator for which the candidate images are requested.

User interaction branching engine 208 is configured to present, at the user interface, the initial/first set of candidate video elements that is output by the model in response to the initial/first prompt. In some embodiments, the initial/first set of candidate video elements is presented at the user interface to appear as if the candidate video elements are branching out/exploding out from the base data as a result of the user selecting/inputting an initial/first modifying action. Along with the presentation of the initial/first set of candidate video elements at the user interface, user interaction branching engine 208 is configured to receive a user selection of one candidate video element (which may optionally be edited by the user within the user interface) among the initial/first set and a second modifying action. For example, the second modifying action may be a presented, enumerated static modifying action or a dynamically user input user interactive action that is to be used to be performed on the selected candidate video element to generate the subsequent set of candidate video elements. In response to the user's indication of the second modifying action along with the selection of the candidate video element from the initial/first set, user interaction branching engine 208 is configured to request model prompting engine 210 to generate a subsequent prompt to a corresponding machine learning model corresponding to the specified, single video element type. In some embodiments, the second prompt was generated by model prompting engine 210 based at least in part on the selected candidate video element, the obtained second modifying action, and video creator-specific information (profile data) associated with the user for which candidate video elements were being generated. In some embodiments, the base data is also included in the second prompt along with the currently selected candidate video element because both are references for subsequent video element iterations and each can be assigned a respective weight in the prompt.

User interaction branching engine 208 is configured to present, at the user interface, the second/subsequent set of candidate video elements that are output by the model in response to the second/subsequent prompt. In some embodiments, the second/subsequent set of candidate video elements is presented at the user interface to appear as if the candidate video elements are branching out/exploding out from the candidate video element that was selected from the initial/first/previous set as a result of the user select/input second/subsequent modifying action. The user may continue to select another candidate within the second/subsequent set of candidate video elements and then indicate a third/subsequent modifying action, as described above, to cause user interaction branching engine 208 to generate the next iteration of candidate video elements until the user no longer wishes to continue the iterative process. For example, the user may stop iterating through the candidate generation process when the user determines that a candidate video element (e.g., within the most recently generated set) meets their criteria (e.g., for being included in a new video that they will produce). At any time in the candidate video element generation process, the user can save the current state of the iterative process. In response to the user's indication to save the current state of a session/instance of the candidate video element generation process, user interaction branching engine 208 is configured to store a data structure that represents the base data, as well as each iteration of selected candidate video element, the user indicated modifying action to be performed on the selected candidate video element, and resulting sets of candidate video elements in a tree-based data structure at candidate video element data structure storage 212 (e.g., comprising a database). In various embodiments, a data structure comprising hierarchical data (e.g., a tree-based data structure that describes the branching relationships among the base input data, the first set of candidate video elements, the second set of candidate video elements, and the selected candidate video elements thereof, etc.) is stored at candidate video element data structure storage 212. For example, in this data structure, the base data may comprise a node in a higher-level layer (e.g., the root) of the tree and each subsequent set of candidate video elements that is generated/iterated from a selected node/candidate video element from a previous, higher layer are represented as nodes in a subsequent, lower layer in the tree. For example, the last set of candidate video elements that were generated in the session are stored as leaf nodes in the deepest/lowest level of the tree and each earlier generated set of candidate video elements are represented as nodes in a higher level of the tree. In some embodiments, the series of nodes comprising the candidate video elements that are selected from each subsequent layer/set of candidates in the tree is referred to as the selected “current path” within the tree.

For example, a user may request to receive candidate video elements corresponding to multiple video element types (“multi-modal” operation) associated with a single project when the user seeks assistance with ideating several related tasks/aspects in the process of producing a new video to be uploaded to the video platform server. In the event that the request is for a plurality of video element types, then user interaction branching engine 208 is configured to obtain base data that serves as an initial value for an initial/currently selected video element type. User interaction branching engine 208 is configured to present the base data corresponding to the specified single video element type at the user interface and prompt the user to indicate (e.g., via selection of a static modifying action or input of a user interactive modifying action) an initial/first modifying action to be performed on the base data to generate the initial/first set of candidate video elements corresponding to the initial/currently selected video element type. In response to either of the user's indication of the initial/first modifying action or the user's submission of an input user interactive modifying action, user interaction branching engine 208 is configured to request model prompting engine 210 to generate a first prompt to a corresponding machine learning model corresponding to the initial/currently selected video element type based on the received, initial/first modifying action. In some embodiments, the first prompt was generated by model prompting engine 210 based at least in part on the base data, an optionally received user provided description input that further describes the base data, the obtained initial/first modifying action, and video creator-specific information (which is sometimes referred to as “profile data”) associated with the video creator for which candidate video elements were being generated. User interaction branching engine 208 is configured to present, at the user interface, the initial/first set of candidate video elements corresponding to the initial/currently selected video element type that is output by the model in response to the initial/first prompt. During the multi-modal operation, at any time, the user can select a candidate video element corresponding to the currently selected video element type to serve as a “pinned” or “favorited” candidate video element for that element type. Also, during multi-modal operation, at any time, the user can switch/toggle among the two or more candidate video element types (e.g., that are associated with the same project/session) for which to generate new candidate video elements in ways similar to what is described for candidate video element generation during the “single mode” operation. However, unlike single mode operation, during multi-modal operation, in response to a selection of a candidate video element from a set of candidate video elements corresponding to a currently selected video element type, a new prompt that is generated by model prompting engine 210 includes not only the selected candidate video element from the currently selected video element type but also includes the pinned/favorited candidate video elements, if any, that had been selected by the user for the other video element types that belong to this same project/session. As a result, the generation of each new set of candidate video elements corresponding to the currently selected video element type is additionally constrained by the pinned/favorited candidate video elements, if any, that have been indicated by the user for even the currently not selected video element types associated with the same project/session. By constraining the generation of new candidate video elements corresponding to the currently selected candidate video element type based on the pinned/favorited candidate video elements of the other element type(s), the new candidate video elements corresponding to the currently selected candidate video element type can be steered to be consistent with the previously indicated pinned/favorited candidate video elements of the other element type(s) because all of the pinned/favorited candidate video elements may be used together for one project/video.

Session restoration engine 214 is configured to restore a session of candidate video element generation at a user interface in response to a user selection of that stored session. To restore the series of branching/exploding candidate video elements that had already been generated for that session, session restoration engine 214 is configured to retrieve the data structure corresponding to that session from candidate video element data structure storage 212. Then, based on that retrieved data structure, session restoration engine 214 is configured to generate the interactive visual comprising the series of branching/exploding candidate video elements that had already been generated for that session and then present the visualization at the user interface. The user can interact with the restored session and continue to select candidate video elements and provide a modifying action to be performed on each selected candidate video element at any point in the tree and not necessarily from the most recently generated leaf nodes.

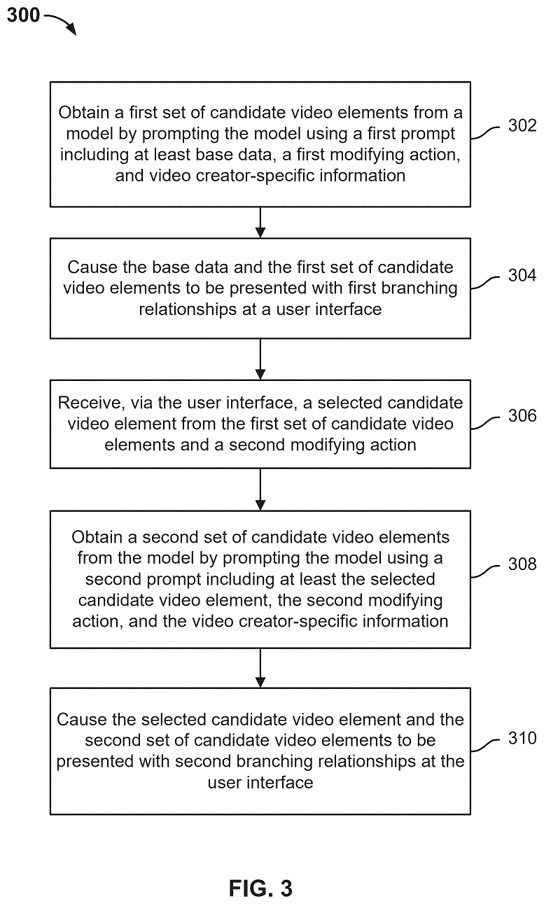

FIG. 3 is a flow diagram showing an embodiment of a process for generating branching candidate video elements in accordance with some embodiments. In some embodiments, process 300 may be implemented at candidate video element branching system 104 of FIG. 1.

At 302, a first set of candidate video elements is obtained from a model by prompting the model using a first prompt including at least base data, a first modifying action, and video creator-specific information. The first prompt is generated in response to a user's request for iterative candidate video element generation corresponding to a specified video creator. The request may have been for a single video element type (“single mode” operation) or for two or more video element types (“multi-mode” operation) associated with a single project/session. The base data (e.g., which is an initial value for the current video element type) comprises user input, for example. The modifying action comprises a text-based action to be performed on the base data to generate the first set of candidate video elements. The first modifying action may be either selected by the user from a set of enumerated static modifying actions that are presented at the user interface or dynamically input by the user within an input window at the user interface. The video creator-specific information comprises profile data of the specified video creator (e.g., including biographic descriptions and/or data derived from historical videos that have been uploaded by the video creator to a video platform server). At least the base data, the first modifying action, and the video creator-specific information are included in a generated first prompt that instructs a machine learning model corresponding to the video element type associated with the request to generate candidate video elements by performing the first modifying action on the base data and constrained to the style/characteristics of the specified video creator.

At 304, the base data and the first set of candidate video elements are caused to be presented with first branching relationships at a user interface. In some embodiments, the first modifying action is also presented with the base data and the first set of candidate video elements.

At 306, a selected candidate video element and a second modifying action are received via the user interface from the first set of candidate video elements. A candidate video element from the first set is then selected by a user at the user interface as the candidate video element from which to iterate the subsequent set of candidate video elements. To generate this subsequent set of candidate video elements, a second modifying action to be performed on the selected candidate video element is also received.

At 308, a second set of candidate video elements is obtained from the model by prompting the model using a second prompt including at least the selected candidate video element, the second modifying action, and the video creator-specific information. At least the selected candidate video element, the second modifying action, and the video creator-specific information are included in a generated second prompt that instructs a machine learning model corresponding to the video element type associated with the request to generate candidate video elements by performing the second modifying action on the selected candidate video element and constrained to the style/characteristics of the specified video creator.

At 310, the selected candidate video element and the second set of candidate video elements are caused to be presented with second branching relationships at the user interface. In some embodiments, the second modifying action is also presented with the selected candidate video element and the second set of candidate video elements.

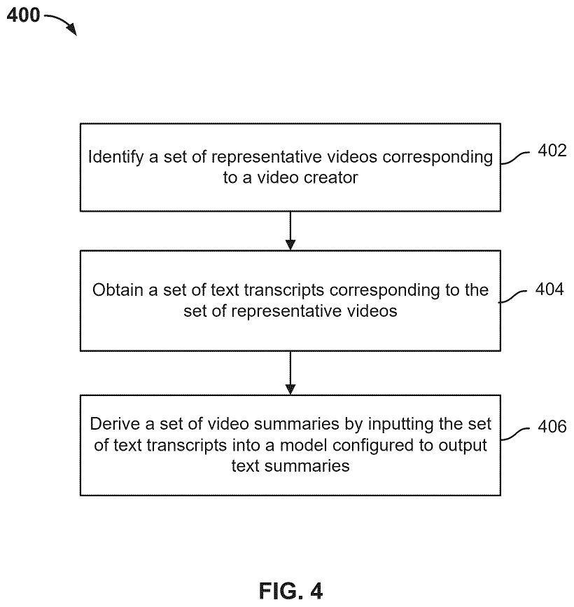

FIG. 4 is a flow diagram showing an example of a process for deriving a set of video summaries corresponding to a video creator's representative videos in accordance with some embodiments. In some embodiments, process 400 may be implemented at candidate video element branching system 104 of FIG. 1.

Process 400 is an example process for identifying a subset of videos that are representative of videos that are produced and/or uploaded to the video platform server by a video creator. In a first example, process 400 can be used to derive data from identified representative videos belonging to a video creator to use to include as the creator's profile data within a prompt to a model for generating candidate video elements.

At 402, a set of representative videos corresponding to a video creator is identified. In some embodiments, the set of representative videos corresponding to a video creator is identified as a subset of “overperforming” videos associated with the creator at the video platform server. The following is one example technique for identifying “overperforming” videos associated with the creator: The set of videos that have been produced and/or uploaded at the video platform server is queried from the video platform server. A “view count” comprising the number of times that an audience member has viewed at least a predetermined portion of each representative video is obtained from the video platform server, which maintains such information as dynamic video metadata. A “cumulative view count” comprising the total view count on each representative video during a predetermined window of time is obtained from the video platform server, which maintains such information as dynamic video metadata. For example, a predetermined window of time is between a start time (e.g., the time after which the video was uploaded/shared on a video platform server) and an end time (e.g., after the first seven days of the video's upload). The average of the video's cumulative view counts is determined. Those videos whose respective cumulative view counts are greater than the average view count are identified as “overperforming.” As such, an “overperforming” video is a video with a cumulative view count (or other level of audience interaction) that is relatively greater than the average view count of the videos in the set over the time window defined by a predetermined start and end time (e.g., over the first seven days from the video's upload) and is therefore not just a video with potentially a large absolute cumulative view count. Due to its relatively high audience interaction in the period immediately after its release, an “overperforming” video can be considered to be a particularly successful video and the traits thereof are desirable to influence the generation of candidate video elements for subsequent videos.

At 404, a set of text transcripts corresponding to the set of representative videos is obtained. A text transcript of each representative video is determined programmatically from the audio track of that video using audio-to-text techniques.

At 406, a set of video summaries is derived by inputting the set of text transcripts into a model configured to output text summaries. For example, as mentioned above, a short text-based summary (e.g., a logline) of each representative video is determined by inputting the text transcription into an obtained model that is configured to output a logline based on the text transcription. As such, a logline is determined from the text transcription of each representative video.

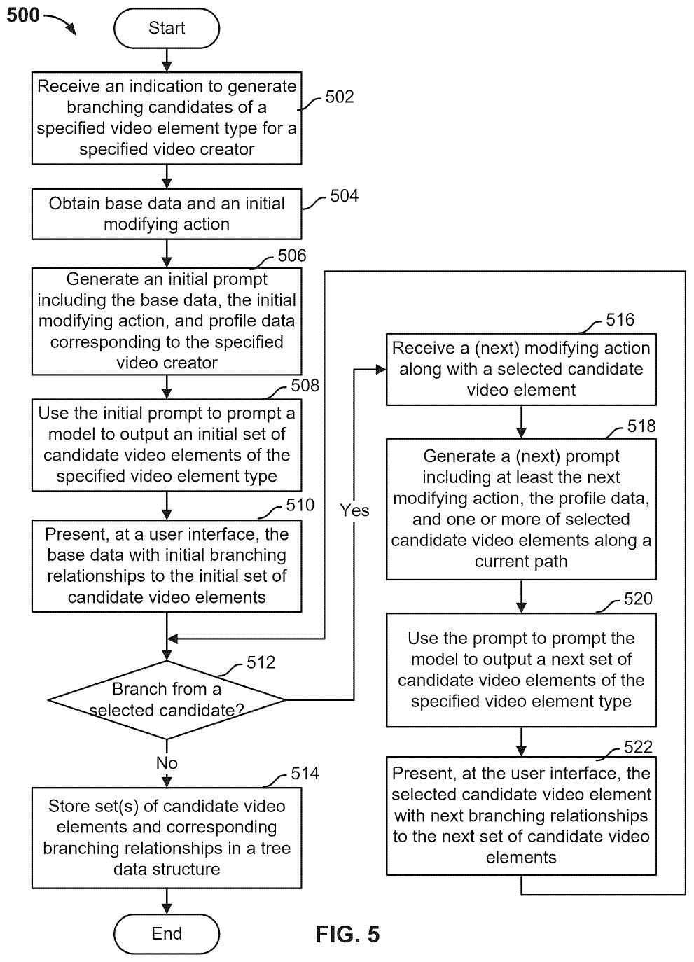

FIG. 5 is a flow diagram showing an example of a process for generating candidate video elements corresponding to a single, selected video element type in accordance with some embodiments. In some embodiments, process 500 may be implemented at candidate video element branching system 104 of FIG. 1. In some embodiments, process 300 of FIG. 3 may be implemented using process 500.

Process 500 is an example process for generating candidate video elements corresponding to a single, selected video element type (“single mode” operation) for a video creator. Process 500 can be used to iteratively generate and visually represent sets of candidate video elements in response to user feedback.

At 502, an indication to generate branching candidates of a specified video element type for a specified video creator is received.

At 504, base data and an initial modifying action are obtained. In some embodiments, the user can optionally submit a text-based description or context to associate with the base data.

At 506, an initial prompt including the base data, the initial modifying action, and profile data corresponding to the specified video creator is generated.

At 508, the initial prompt is used to prompt a model to output an initial set of candidate video elements of the specified video element type. The model comprises a machine learning model that corresponds to the specified video element type.

At 510, the base data is presented with initial branching relationships to the initial set of candidate video elements at a user interface. In some embodiments, the initial modifying action is also presented/highlighted at the user interface so as to identify the action that was performed on the base data to generate the initial set of candidate video elements.

At 512, whether additional candidate video elements are to branch from a selected candidate video element is determined. In the event that additional candidate video elements are to branch from a selected candidate video element, control is transferred to 516. Otherwise, in the event that additional candidate video elements are not to branch from the selected candidate video element, control is transferred to 514. In various embodiments, additional candidate video elements are to branch from a candidate video element within a previously generated set of candidate video elements when a user selection of one such candidate video element is received via the user interface. For example, if the user wanted to iterate through to a next batch of candidate video elements to review further options for a future video production, then the user can make a selection of any previously generated candidate video element (e.g., in either the most recently generated set or any set generated before that). But if the user did not choose to iterate through to a next batch of candidate video elements (e.g., because the user has identified a candidate video element that meets their criteria and/or the user wishes to save the state of the candidate video element generation to edit later), then the user can indicate to close the user interface or to otherwise pause the iterative generation process.

In some embodiments, the user can optionally edit the selected candidate video element that they have selected upon which to iterate.

At 514, set(s) of candidate video elements and corresponding branching relationships are stored in a tree data structure. The series of sets of candidate video elements are stored in a tree data structure associated with the current session. In some embodiments, among the sets, the series of candidate video elements thereof that were user selected for iterative candidate video elements are denoted in the data structure as the “current path” of the tree.

At 516, a (next) modifying action along with a selected candidate video element is received.

At 518, a (next) prompt including at least the next modifying action, the profile data, and one or more of selected candidate video elements along a current path is generated. The next prompt may include, in addition to the next modifying action and the profile data of the video creator, at least the most recently selected candidate video element and potentially, one or more previously selected candidate video elements within the current path (including the base data). When the base data and each other previously selected candidate video element of the current path are included in the prompt, each value is assigned a corresponding weight (e.g., more recently selected candidate video elements are assigned higher weights than older selected candidate video elements/the base data so as to attribute greater influence to more temporally proximate signals).

At 520, the prompt is used to prompt the model to output a next set of candidate video elements of the specified video element type.

At 522, the selected candidate video element is presented with next branching relationships to the next set of candidate video elements at the user interface. In some embodiments, the next modifying action is also presented/highlighted at the user interface so as to identify the action that was performed on the most recently selected candidate video element to generate the current/new set of candidate video elements.

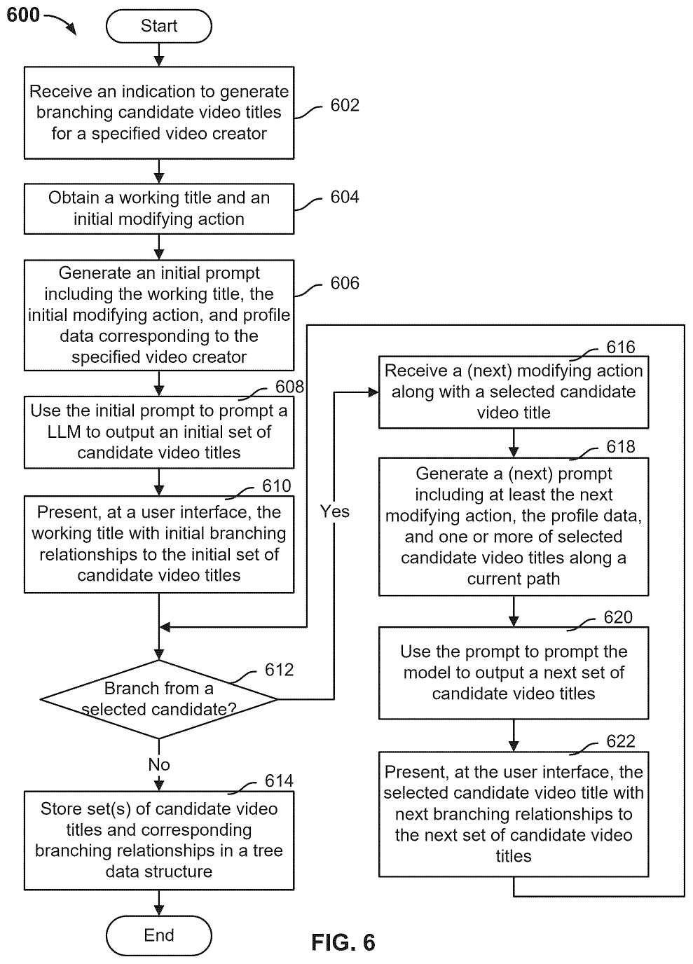

FIG. 6 is a flow diagram showing an example of a process for generating candidate video titles in accordance with some embodiments. In some embodiments, process 600 may be implemented at candidate video element branching system 104 of FIG. 1. In some embodiments, process 500 may be implemented, at least in part, using process 600 of FIG. 6.

Process 600 is an example process for generating candidate video elements for the specific example video element of video titles (in the “single mode” operation) for a video creator. A “video title” is the name that represents a video at a platform video server. Process 600 can be used to iteratively generate and visually represent sets of candidate video titles in response to user feedback.

At 602, an indication to generate branching candidates of video titles for a specified video creator is received.

At 604, a working title and an initial modifying action are obtained. In some embodiments, the user can optionally submit a text-based description or context to associate with the working title.

At 606, an initial prompt including the working title, the initial modifying action, and profile data corresponding to the specified video creator is generated.

At 608, the initial prompt is used to prompt a LLM to output an initial set of candidate video titles. In some embodiments, the LLM may be a third-party LLM. In some embodiments, the LLM may be a LLM that has been specifically trained on the profile data of the specified video creator, and also data and metadata associated with videos that have been historically uploaded by the specified video creator to the video platform server.

At 610, the working title is presented with initial branching relationships to the initial set of candidate video titles at a user interface. In some embodiments, the initial modifying action is also presented/highlighted at the user interface so as to identify the action that was performed on the working title to generate the initial set of candidate video titles.

At 612, whether additional candidate video titles are to branch from a selected candidate video title is determined. In the event that additional candidate video titles are to branch from a selected candidate video title, control is transferred to 616. Otherwise, in the event that additional candidate video titles are not to branch from the selected candidate video title, control is transferred to 614. In various embodiments, additional candidate video titles are to branch from a candidate video title within a previously generated set of candidate video titles when a user selection of one such candidate video title is received via the user interface. For example, if the user wanted to iterate through to a next batch of candidate video titles to review further options for a future video production, then the user can make a selection of any previously generated candidate video title (e.g., in either the most recently generated set or any set generated before that). But if the user did not choose to iterate through to a next batch of candidate video titles (e.g., because the user has identified a candidate video title that meets their criteria and/or the user wishes to save the state of the candidate video title generation to edit later), then the user can indicate to close the user interface or to otherwise pause the iterative generation process.

In some embodiments, the user can optionally edit the selected candidate video title that they have selected upon which to iterate.

At 614, set(s) of candidate video titles and corresponding branching relationships are stored in a tree data structure. The series of sets of candidate video titles are stored in a tree data structure associated with the current session. In some embodiments, the series of candidate video titles that were user selected for iterative candidate video title elements are denoted in the data structure as the “current path” of the tree.

At 616, a next modifying action along with a selected candidate video title are received.

At 618, a next prompt including at least the next modifying action, the profile data, and one or more of selected candidate video titles along a current path is generated. The next prompt may include, in addition to the next modifying action and the profile data of the video creator, at least the most recently selected candidate video title and potentially, one or more previously selected candidate video titles within the current path (including the working title). When the base data and each other previously selected candidate video title of the current path are included in the prompt, each value is assigned a corresponding weight (e.g., more recently selected candidate video titles are assigned higher weights than older selected candidate video titles/the working title so as to attribute greater influence to more temporally proximate signals).

At 620, the prompt is used to prompt the model to output a next set of candidate video titles of the specified video title.

At 622, the selected candidate video title is presented with next branching relationships to the next set of candidate video titles at the user interface. In some embodiments, the next modifying action is also presented/highlighted at the user interface so as to identify the action that was performed on the most recently selected candidate video title to generate the current/new set of candidate video titles.

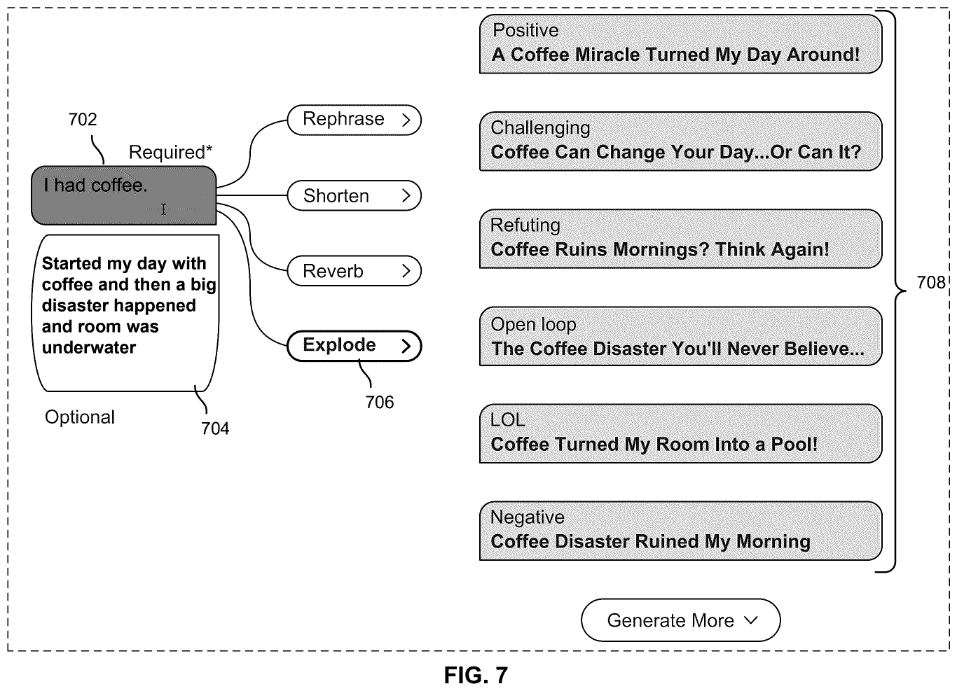

FIG. 7 is a diagram showing a first example user interface associated with generating branching sets of candidate video titles in accordance with some embodiments. In some embodiments, the interaction with a user and the presentation in FIG. 7 are implemented, at least in part, using process 600 of FIG. 6. In the example of FIG. 7, a particular video creator (or another user acting on behalf of the video creator) was interacting with the user interface to request iterations of additional candidate video titles after initially submitting a working title of “I had coffee” in base input data field 702. The user had also provided an additional description to the working title of “Started my day with coffee and then a big disaster happened and room was underwater” in description input field 704. Then, the user had selected the presented static modifying action of “Explode” 706 among the presented, enumerated modifying actions of “Rephrase,” “Shorten,” “Reverb,” and “Explode.” In response to the user inputs and selections, a prompt was generated for a LLM. In some embodiments, the prompt was generated based at least in part on the working title input at field 702, the description input at field 704, the selected static modifying action 706, and profile data/video creator-specific information (not shown in FIG. 7) associated with the user for which candidate video titles were being generated. In some embodiments, the static modifying action of “Explode” entails that a corresponding prompt will be generated to request the model to generate respective candidate video titles that modify the working title (or previously selected candidate video title) based on different descriptors/styles (e.g., positive, challenging, refuting, open loop, LOL, and negative). In some embodiments, the first prompt is generated by inserting the constraints (working title input at field 702, the description input at field 704, the selected static modifying action 706, and profile data) into appropriate locations within a predetermined template that corresponds to the static modifying action of “Explode” 706 and also corresponds to the LLM that is designated for generating video titles. In an example, a template for the “Explode” static modifying action includes the specific instructions to the LLM that would cause the model to generate a new set of candidate video titles using the provided constraints and in each manner of several (e.g., 40) predetermined different descriptors (e.g., positive, challenging, refuting, open loop, LOL, negative, exploratory, introspective). In some embodiments, the LLM that is to be prompted using the generated prompt comprises a base, third-party LLM. In some embodiments, the LLM that is to be prompted using the generated prompt comprises a language model that has been trained to generate output in the format of the requested type of video element, which in the example of FIG. 7, is video titles. In some embodiments, the video creator-specific information associated with the current video creator comprises the summaries or loglines that are generated from the text transcriptions of a representative set of videos that had been previously generated/uploaded by the user to a video platform server (e.g., as determined using a process such as process 4 of FIG. 4). The LLM is then prompted with the prompt that was generated based on the inputs and selections described above. The output of the model in response to that prompt includes the set of candidate video titles 708 that are presented in FIG. 7. As mentioned above, because the presented static modifying action of “Explode” 706 was selected, each of the candidate video titles in set 708 is a different iteration as generated by the LLM upon the working title input into field 702 in the context of the description input at field 704 based on different descriptors/styles (e.g., positive, challenging, refuting, open loop, LOL, and negative). Furthermore, because the prompt to the LLM also provided the model with representative data specific to the video creator, each of the output candidate video titles in set 708 is also constrained to the style as defined by the video creator-specific information that was included in the prompt.

While not shown in FIG. 7, in some embodiments, each candidate video element within the current set of candidate video elements may be presented with a corresponding visual indication that denotes a predicted metric for the video element. For example, the predicted metric may be a predicted popularity of a video that is associated with the video element. For example, the predicted metric may appear as a visual indication (e.g., a star) that indicates at least a threshold level of the predicted metric or the predicted metric may appear as a numeric value that represents the metric. In some embodiments, the predicted metric is determined based on the components (e.g., text or image-based) within the corresponding candidate video element.

While not shown in FIG. 7, in some embodiments, a prompt template for the “Explode” static modifying action (for any candidate video element type) may include the specific instructions to the LLM that would cause the model to generate a new set of candidate video elements using the provided constraints and in each manner of a first set of predetermined descriptors (e.g., positive, challenging, refuting, open loop, LOL, negative, exploratory, introspective) and also in each manner of a second set of dynamically determined descriptors. In some embodiments, for the “Explode” static modifying action, a set of dynamically determined descriptors can be customized for the specified video creator. For example, the set of dynamically determined descriptors that are customized for the specified video creator can be determined based on custom descriptors that are generated by a LLM in response to a prompt for descriptors that are constrained by profile data of the specified video creator, or tags (or other metadata) that have been assigned to historical videos that have been uploaded by the specified video creator to a video platform server. For example, if a serious podcaster type of video creator selected to “Explode” a video element comprising a concept or a B-plot, one of the LLM-customized descriptors/explode type could be “open minded exploration.” But if the video creator were a comedian podcaster, one of the LLM-customized descriptors/explode type could be “faux outrage.” In another example, if a video creator were a sports and comedy group selected to “Explode” a video element comprising a concept or a B-plot, a couple of the LLM-customized descriptors/explode type could be “unexpected partnerships” and “audience interactive elements.” But if the video creator was a comedy skit creator, a couple of the LLM-customized descriptors/explode type could be “unexpected allies” and “mystery twist.” For example, these dynamically generated video element descriptors of the “Explode” modifying action are customized to each specific video creator and are only visible for that creator within the generated candidate video elements but would show up along the predetermined descriptors/explode types (e.g., positive, challenging, refuting, open loop, LOL, negative, exploratory, introspective) that are visible for all video creators.

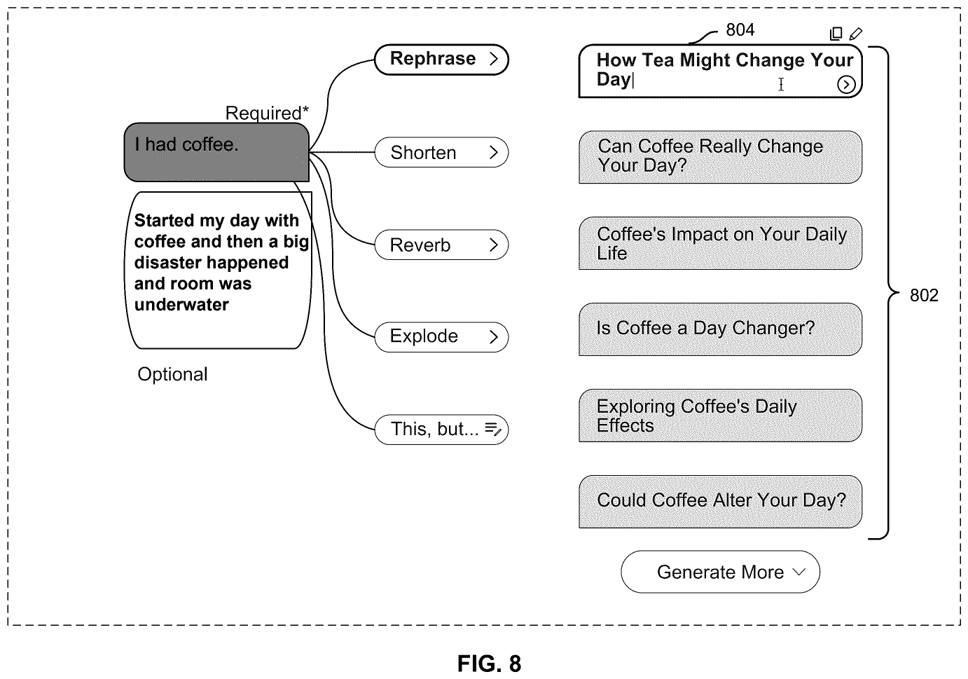

FIG. 8 is a diagram showing a second example user interface associated with generating branching sets of candidate video titles in accordance with some embodiments. In the example of FIG. 8, set of candidate video titles 802 was generated by a LLM in response to a prompt for candidate video elements based on at least a working video title and video creator specific information. In the example of FIG. 8, the video creator (or another user acting on behalf of the video creator user) wants to iterate upon a selected one of the candidate video titles of set 802 but wanted to first edit the selected candidate video title. For example, the user may want to cause the next iteration of candidate video titles to be generated from a selected one of the candidate video titles of set 802 but would like to modify the text of that candidate before including that candidate in a next prompt to the LLM. In particular, the user wanted to tweak the original text of selected candidate video title 804, which they are able to do by selecting selected candidate video title 804 and directly updating the text within a corresponding input window. Thereafter, the user can select the edited version of selected candidate video title 804 and then indicate a modifying action to be performed on edited selected candidate video title 804 to cause a new prompt to be generated for the LLM. This new prompt would include the edited/updated version of selected candidate video title 804 instead of the original version of selected candidate video title 804 that had been output by the LLM in response to a previous prompt.

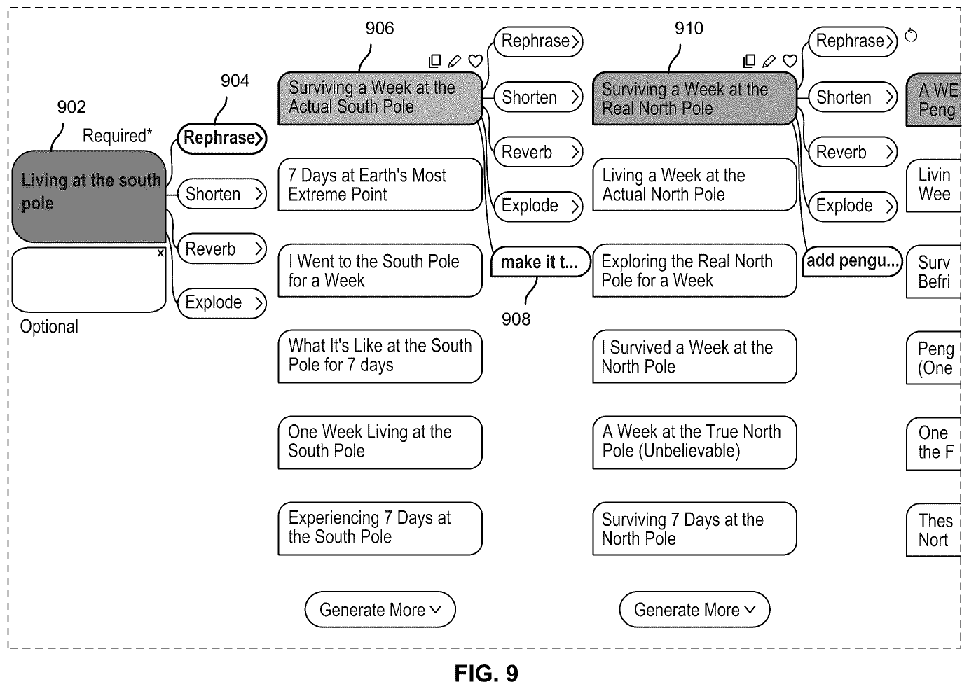

FIG. 9 is a diagram showing a third example user interface associated with generating branching sets of candidate video titles in accordance with some embodiments. In the example of FIG. 9, a video creator user (or another user acting on behalf of the video creator user) was interacting with the user interface to request iterations of additional candidate video titles after first submitting a working title of “Living at the south pole” in base input data field 902. The user did not provide any description in the input field in the example user interface of FIG. 9. The user had selected the presented static modifying action of “Rephrase” among the presented, enumerated modifying actions of “Rephrase,” “Shorten,” “Reverb,” and “Explode.”In response to the user inputs and selections, a first prompt was generated for the LLM. In some embodiments, the first prompt was generated based at least in part on the working title input at field 902, a set of modifications associated with the selected static modifying action of “Rephrase” 904, and profile data/video creator-specific information associated with the user for which candidate video titles were being generated. In some embodiments, the static modifying action of “Rephrase” entails that a corresponding prompt will be generated to request the model to generate respective candidate video titles that modify the working title (or previously selected candidate video title) based on different rephrasing/wordings of the previous video title. In some embodiments, the first prompt is generated by inserting the constraints (working title input at field 902 and video creator-specific profile data) into appropriate locations within a predetermined template that corresponds to the static modifying action of “Rephrase” 904 and also corresponds to the LLM that is designated for generating video titles. For example, a template includes the specific instructions to the LLM that would cause the model to generate a new set of candidate video titles by rephrasing the working title within the provided constraints in a number of different ways but within the provided constraints. The LLM is then prompted with the first prompt that was generated as described above. The output of the model in response to that prompt is set of candidate video titles 906 that is presented in FIG. 9. As mentioned, because the presented static modifying action of “Rephrase” 904 was selected, each of the candidate video titles in set 906 is an iteration upon the working title input into base input data input field 902 with different rephrasing/wording.

In the example of FIG. 9, the user wanted to receive additional candidate video titles that iterate upon/are modified from one of set of candidate video titles 906 and so the user selected the candidate video title of “Surviving a Week at the Actual South Pole.” In some embodiments, alternative to an enumerated static modifying action, the user can submit a dynamic user interactive modifying action to use to modify the selected candidate video title. In this particular instance, instead of selecting from one of the enumerated static modifying actions (“Rephrase,” “Shorten,” “Reverb,” and “Explode”), the user provided user interactive action 908 of “make it the North Pole.” In response to such user selections, a second prompt was generated for the LLM. In some embodiments, the second prompt was generated based at least in part on the selected candidate video title of “Surviving a Week at the Actual South Pole,” user interactive action 908 of “make it the North Pole,” and video creator-specific information associated with the user for which candidate video titles were being generated. In some embodiments, the working title is also included in the prompt along with the currently selected candidate video title of “Surviving a Week at the Actual South Pole” because both are references for subsequent video title iterations and each can be assigned a respective weight in the prompt. For example, the currently selected candidate video title of “Surviving a Week at the Actual South Pole” is assigned a higher weight (e.g., because it was provided more recently) and the working title is assigned a lower weight (e.g., because it was provided less recently). The working title and the currently selected candidate video title of “Surviving a Week at the Actual South Pole” are both considered to be in the current path of user selection among the tree-shaped iteration of candidate video titles. In some embodiments, the second prompt is generated by inserting the constraints (working title input at field 902, selected candidate video title of “Surviving a Week at the Actual South Pole,” user interactive action 908 of “make it the North Pole,” and/or video creator-specific profile data) into appropriate locations within a predetermined template that corresponds to user interactive modifying actions and also corresponds to the LLM that is designated for generating video titles. For example, a template includes the specific instructions to the LLM that would cause the model to generate a new set of candidate video titles by rephrasing the working title within the provided constraints in a number of different ways. The LLM is then prompted with the second prompt, as described above. The output of the model in response to the second prompt are set of candidate video titles 910 that are presented in FIG. 9. As mentioned above, because user interactive action 908 of “make it the North Pole” was provided, each of the candidate video titles in set 910 is a different iteration upon the selected candidate video title of “Surviving a Week at the Actual South Pole” but with the modified constraint that the location has now changed to the North Pole.

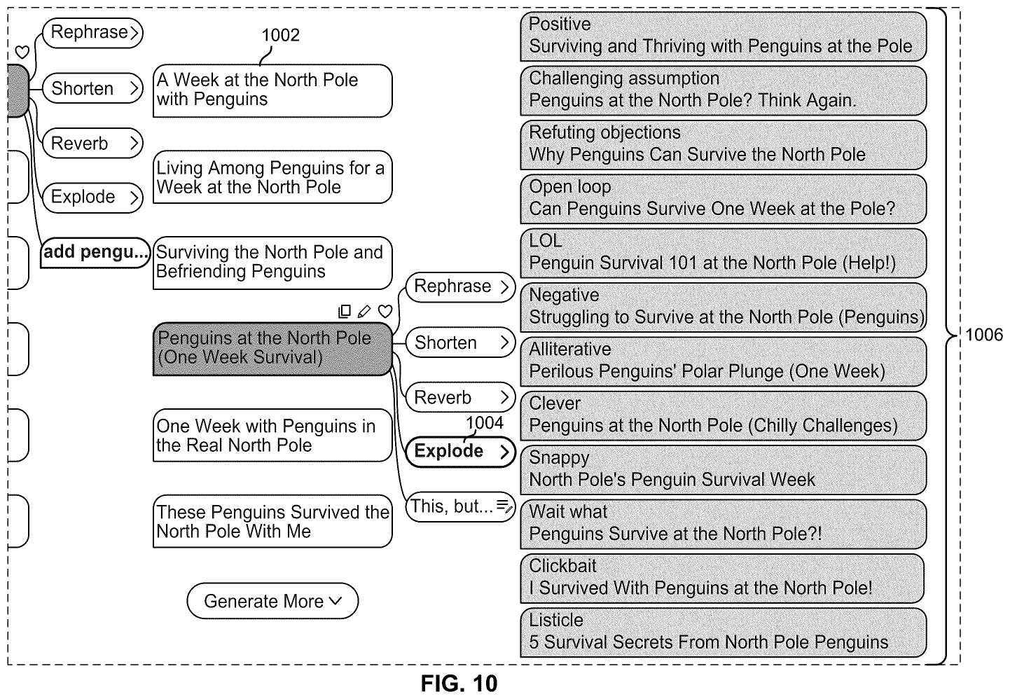

FIG. 10 is a diagram showing a fourth example user interface associated with generating branching sets of candidate video titles in accordance with some embodiments. In the example of FIG. 10, a video creator user (or another user acting on behalf of the video creator user) had been interacting with the user interface to request one or more iterations (sets) of additional candidate video titles after first submitting a working title of “Living at the south pole” in a base input data field (not visible in FIG. 10). As shown in FIG. 10, the user had selected the candidate video title of “Penguins at the North Pole (One Week Survival)” among the latest set of candidate video titles, set 1002, along with the presented static modifying action 1004 of “Explode” among the presented, enumerated static modifying actions of “Rephrase,” “Shorten,” “Reverb,” and “Explode.” In response to the user inputs and selections, a prompt was generated for the LLM. In some embodiments, the prompt was generated based at least in part on the selected candidate video title of “Penguins at the North Pole (One Week Survival),” static modifying action 1004 of “Explode,” and profile data/video creator-specific information associated with the user for which candidate video titles were being generated. In some embodiments, the prompt is generated by inserting the constraints (each previously selected candidate video title and corresponding modifying action in the current path, including the working title and the currently selected candidate video title of “Penguins at the North Pole (One Week Survival),” because all are references for subsequent video title iterations and each can be assigned a respective weight, and/or video creator-specific profile data) into appropriate locations within a predetermined template that corresponds to the static modifying action of “Explode” that instructs the LLM and also corresponds to the LLM that is designated for generating video titles. For example, a template includes the specific instructions to the LLM that would cause the model to generate a new set of candidate video titles by reworking the currently selected candidate video title of “Penguins at the North Pole (One Week Survival)” in various different directions (e.g., based on provided different or random qualitative variables) within the provided constraints. The LLM is then prompted with the prompt as described above. The output of the model in response to that prompt is set of candidate video titles 1006 that is presented in FIG. 10. As mentioned above, because static modifying action 1004 of “Explode” was submitted, each of the candidate video titles in set 1006 is an iteration upon the selected candidate video title of “Penguins at the North Pole (One Week Survival)” that takes the idea in different qualitative directions and is labeled with that corresponding qualitative variable (Positive, Challenging assumption, Refuting objections, Open loop, LOL, Negative, Affirmative, Clever, Snappy, Wait what, Clickbait, Listicle) with which it was generated by the LLM.

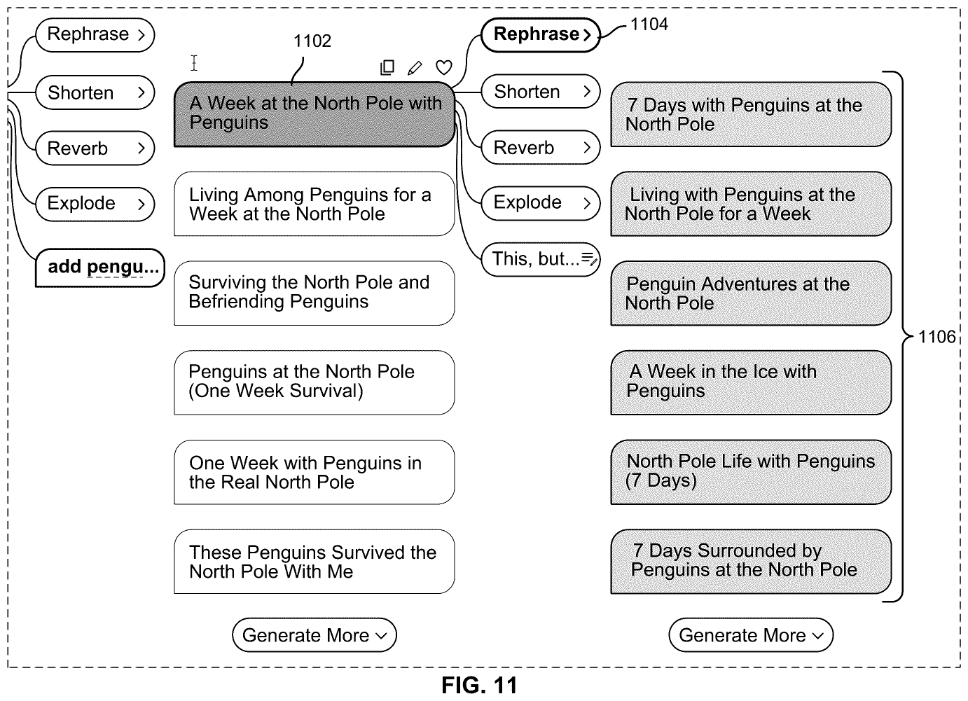

FIG. 11 is a diagram showing a fifth example user interface associated with generating branching sets of candidate video titles in accordance with some embodiments. In the example of FIG. 11, a video creator user (or another user acting on behalf of the video creator user) had been interacting with the user interface to request one or more iterations of additional candidate video titles after first submitting a working title of “Living at the south pole” in a base input data field (not visible in FIG. 11). In some embodiments, even after a user selects a candidate video element (e.g., title) from a set (a layer in the tree) of candidate video elements upon which to iterate, the user can return to an earlier set of candidate video elements/layers to select a different, previously not selected candidate video element upon which to iterate new candidate video elements. After the user had selected the candidate video title of “Penguins at the North Pole (One Week Survival)” from set 1102 from which to generate new, modified candidate video titles, as was shown in the example of FIG. 10, the user returned to set 1102 and instead selected the candidate video title of “A Week at the North Pole with Penguins” and static modifying action 1104 of “Rephrase” among the presented, enumerated static modifying actions of “Rephrase,” “Shorten,” “Reverb,” “Explode,” and “This, but . . . ” In response to the user inputs and selections, a prompt was generated for the LLM. In some embodiments, the prompt was generated based at least in part on the selected candidate video title of “A Week at the North Pole with Penguins,” static modifying action 1104 of “Rephrase,” and video creator-specific information associated with the user for which candidate video titles were being generated. In some embodiments, the prompt is generated by inserting the constraints (each previously selected candidate video title and corresponding modifying action in the current path, including the working title and the currently selected candidate video title of “A Week at the North Pole with Penguins,” because all are references for subsequent video title iterations and each can be assigned a respective weight, and/or video creator-specific profile data) into appropriate locations within a predetermined template that corresponds to the static modifying action of “Rephrase” that instructs the LLM that is designated for generating video titles. In some embodiments, because the previously selected candidate video title of “Penguins at the North Pole (One Week Survival)” (as shown in the example of FIG. 10) is no longer part of the selected path of the tree, the candidate video title of “Penguins at the North Pole (One Week Survival)” is not included in the prompt. For example, a template includes the specific instructions to the LLM that would cause the model to generate a new set of candidate video titles by rephrasing the currently selected candidate video title of “A Week at the North Pole with Penguins” in a number of different ways but within the provided constraints. The LLM is then prompted with the prompt as described above. The output of the model in response to that prompt is set of candidate video titles 1106 that is presented in FIG. 11. As shown in FIG. 11, set of candidate video titles 1106 replaces the set of candidate video titles that was previously generated based on previously selected candidate video title of “Penguins at the North Pole (One Week Survival)” (as shown in FIG. 10) because the candidate video title of “Penguins at the North Pole (One Week Survival)” is no longer in the current path of selected candidate video elements. As mentioned above, because static modifying action 1104 of “Rephrase” was submitted, each of the candidate video titles in set 1106 is an iteration upon the selected candidate video title of “A Week at the North Pole with Penguins” but with a different wording.

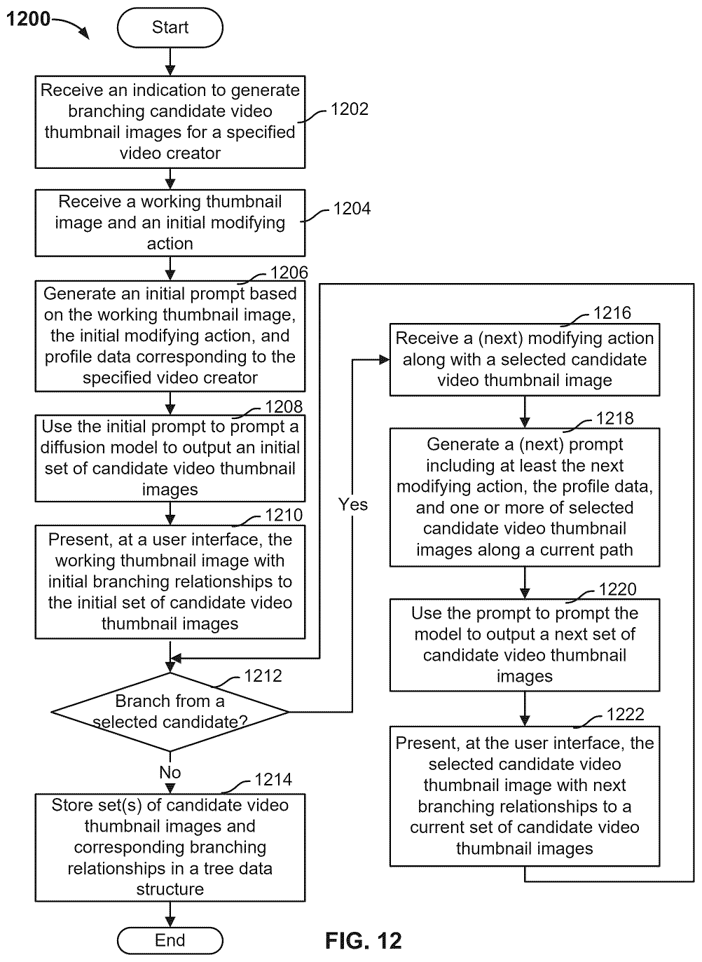

FIG. 12 is a flow diagram showing an example of a process for generating candidate video thumbnail images in accordance with some embodiments. In some embodiments, process 1200 may be implemented at candidate video element branching system 104 of FIG. 1. In some embodiments, process 500 may be implemented, at least in part, using process 1200 of FIG. 12.

Process 1200 is an example process for generating candidate video elements for the specific example video element of video thumbnail images (in the “single mode” operation) for a video creator. A “video thumbnail image” is the image that represents a video at a platform video server. Process 1200 can be used to iteratively generate and visually represent sets of candidate video thumbnail images in response to user feedback.

At 1202, an indication to generate branching candidates of video thumbnail images for a specified video creator is received.

At 1204, a working thumbnail image and an initial modifying action are received. In some embodiments, the user can optionally submit a text-based description or context to be associated with the working thumbnail image.

At 1206, an initial prompt including the working thumbnail image, the initial modifying action, and profile data corresponding to the specified video creator is generated.

At 1208, the initial prompt is used to prompt a diffusion model to output an initial set of candidate video thumbnail images. In some embodiments, the diffusion model may be a third-party LLM. In some embodiments, the diffusion model may be a diffusion model that has been specifically trained on the images that include the likeness of the specified video creator including thumbnail images associated with videos that have been historically uploaded by the specified video creator to the video platform server.

At 1210, the working thumbnail image is presented with initial branching relationships to the initial set of candidate video thumbnail images at a user interface. In some embodiments, the initial modifying action is also presented/highlighted at the user interface so as to identify the action that was performed on the working thumbnail image to generate the initial set of candidate video thumbnail images.

At 1212, whether additional candidate video thumbnail images are to branch from a selected candidate video thumbnail image is determined. In the event that additional candidate video thumbnail images are to branch from a selected candidate video thumbnail image, control is transferred to 1216. Otherwise, in the event that additional candidate video thumbnail images are not to branch from the selected candidate video thumbnail image, control is transferred to 1214. In various embodiments, additional candidate video thumbnail images are to branch from a candidate video thumbnail image within a previously generated set of candidate video thumbnail images when a user selection of one such candidate video thumbnail image is received via the user interface. For example, if the user wanted to iterate through to a next batch of candidate video thumbnail images to review further options for a future video production, then the user can make a selection of any previously generated candidate video thumbnail images (e.g., in either the most recently generated set or any set generated before that). But if the user did not choose to iterate through to a next batch of candidate video thumbnail images (e.g., because the user has identified a candidate video thumbnail image that meets their criteria and/or the user wishes to save the state of the candidate video thumbnail image generation to edit later), then the user can indicate to close the user interface or to otherwise pause the iterative generation process.

At 1214, set(s) of candidate video thumbnail images and corresponding branching relationships are stored in a tree data structure. The series of sets of candidate video thumbnail images are stored in a tree data structure associated with the current session. In some embodiments, the series of candidate video thumbnail images that were user selected for iterative candidate video thumbnail image generation are denoted in the data structure as the “current path” of the tree.

At 1216, a (next) modifying action along with a selected candidate video thumbnail image are received.

At 1218, a (next) prompt including at least the next modifying action, the profile data, and one or more of selected candidate video thumbnail images along a current path is generated. The next prompt may include, in addition to the next modifying action and the profile data of the video creator, at least the most recently selected candidate video thumbnail image and potentially, one or more previously selected candidate video thumbnail images within the current path (including the working thumbnail image). When the base data and each other previously selected candidate video thumbnail image of the current path are included in the prompt, each value is assigned a corresponding weight (e.g., more recently selected candidate video thumbnail images are assigned higher weights than older selected candidate video thumbnail images/the working thumbnail image so as to attribute greater influence to more temporally proximate signals).

At 1220, the prompt is used to prompt the model to output a next set of candidate video thumbnail images of the specified video thumbnail image.

At 1222, the selected candidate video thumbnail image is presented with next branching relationships to the next set of candidate video thumbnail images at the user interface. In some embodiments, the next modifying action is also presented/highlighted at the user interface so as to identify the action that was performed on the most recently selected candidate video thumbnail image to generate the current/new set of candidate video thumbnail images.

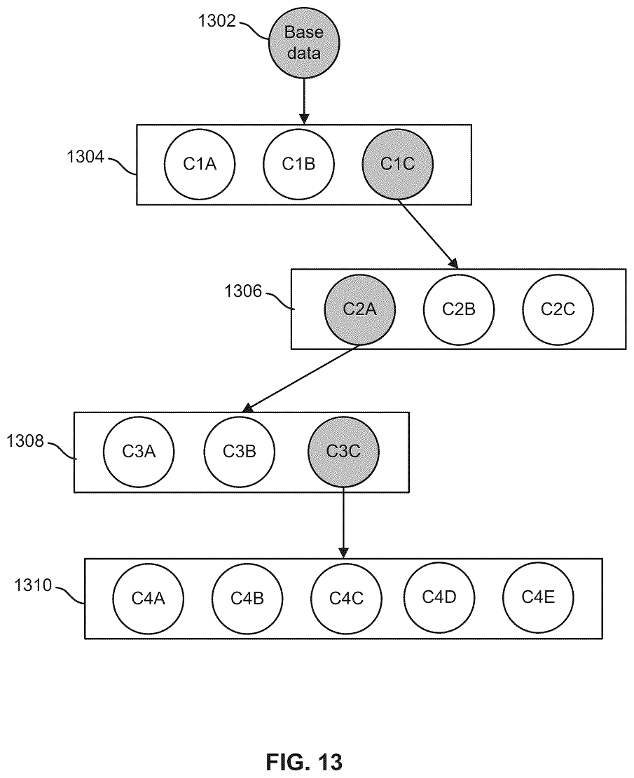

FIG. 13 is a diagram showing an example data structure including hierarchical data corresponding to a series of iterations of candidate video elements that are generated from base data in accordance with some embodiments. In the example of FIG. 13, the data structure comprises a tree-shaped data structure. In some embodiments, the data structure of FIG. 13 corresponds to a session/instance of the candidate video element generation process corresponding to a specified video creator. In the example of FIG. 13, root 1302 of the tree represents the base data (e.g., such as the working video title that was input into a base data input field). The next layer, layer 1304, comprising three nodes, C1A, C1B, and C1C, represents three respective candidate video elements that were generated based on prompting a machine learning model based at least in part on the base data of root 1302 along with a selected static or dynamically input user interactive modifying action, which may be stored with root 1302, for example. From layer 1304, the candidate video element associated with node C1C was selected to further iterate upon and a prompt was generated based at least in part on the candidate video element of node C1C along with a corresponding selected/input modifying action, which may be stored with node C1C. The next layer, layer 1306, comprising three nodes, C2A, C2B, and C2C, represents three respective candidate video elements that were generated based on prompting the model based at least in part on the candidate video element of node C1C along with a corresponding selected/input modifying action. In some embodiments, layer 1306, comprising three nodes, C2A, C2B, and C2C, was generated by prompting the model based at least in part on the current path of user selection within the tree (which includes the series of nodes from the root node to the currently selected node): candidate video element of node C1C along with a corresponding selected/input modifying action, and also base data of root 1302 and where a respective weight is assigned to CIC and base data of root 1302. For example, the weights that are assigned to a node in a prompt increase with the node's depth within the tree. This is because the lower/deeper the node is in a tree, the more recent the underlying candidate video element was selected by the user and the stronger a signal that is represented by the node. From layer 1306, the candidate video element associated with node C2A was selected to further iterate upon and a prompt was generated based at least in part on the candidate video element of node C2A along with a corresponding selected/input modifying action, which may be stored with node C2A. The next layer, layer 1308, comprising three nodes, C3A, C3B, and C3C, represents three respective candidate video elements that were generated based on prompting the model based at least in part on the candidate video element of node C3C along with a corresponding selected/input modifying action. As described above, in some embodiments, the prompt that caused layer 1308, comprising three nodes, C3A, C3B, and C3C, to be generated may have included the current path (base data of root 1302, the candidate video element of node CIC from layer 1304, and the candidate video element of node C2A of layer 1306) as well as respective weights. The last layer, layer 1310, comprising five nodes, C4A, C4B, C4C, C4D, and C4E, represents five respective candidate video elements that were generated based on prompting the model based at least in part on the candidate video element of node C3C along with a corresponding selected/input modifying action. As described above, in some embodiments, the prompt that caused layer 1310 comprising five nodes C4A, C4B, C4C, C4D, and C4E to be generated may have included the current path (base data of root 1302, the candidate video element of node CIC from layer 1304, the candidate video element of node C2A of layer 1306, and the candidate video element of node C3C of layer 1308) as well as respective weights. There is no further layer because the user did not select a candidate video among layer 1310 from which to iterate additional candidates. In the example that is shown in FIG. 13, the current path of user selection within the data structure comprises root node 1302 (which includes the base data), node C1C, node C2A, and node C3C.

While not shown in FIG. 13, after the generation of layer 1310 comprising nodes C4A, C4B, C4C, C4D, and C4E that represent five respective candidate video elements, the user could have selected a candidate video element from a layer higher than (generated earlier than) layer 1310 in the tree-shaped data structure upon which to iterate additional candidates. Specifically, the user could have returned to any of base data of root 1302, a candidate video element of layer 1304, a candidate video element of layer 1306, or a candidate video element of layer 1308. Then, the data structure would be updated to indicate any additional layers of nodes representing new candidate video elements that would branch from that selected candidate video element.

While not shown in FIG. 13, the user can return to select again any previously selected node in the tree-shaped data structure but indicate a different modifying action to cause a different next, lower layer of candidate video elements/nodes to be generated. The data structure would be updated to indicate any alternative additional layer(s) of nodes representing new candidate video elements would branch from that re-selected candidate video element.

In some embodiments, a tree-shaped data structure such as the one shown in FIG. 13 is used to represent the series of branching candidate video elements that are generated in a session. The data structure can be stored in a database so that the session can be restored for additional modification/further iterations.

In some embodiments, tree-shaped data structures such as the one shown in FIG. 13 that represent a session of generated branching candidate video elements can be used as additional training data to retrain the model that was used to generate the candidate video elements of the tree. For example, tree-shaped data structures that represent stored sessions of branching candidate video element generation for a particular video creator can be used to retrain the model so that the weights of the model can be better adjusted to generate subsequent candidate video elements that are in accordance with the training data (e.g., the such training data could cause the subsequently generated candidate video elements to include video elements more similar to the current paths of selected candidate video elements within the data structures).

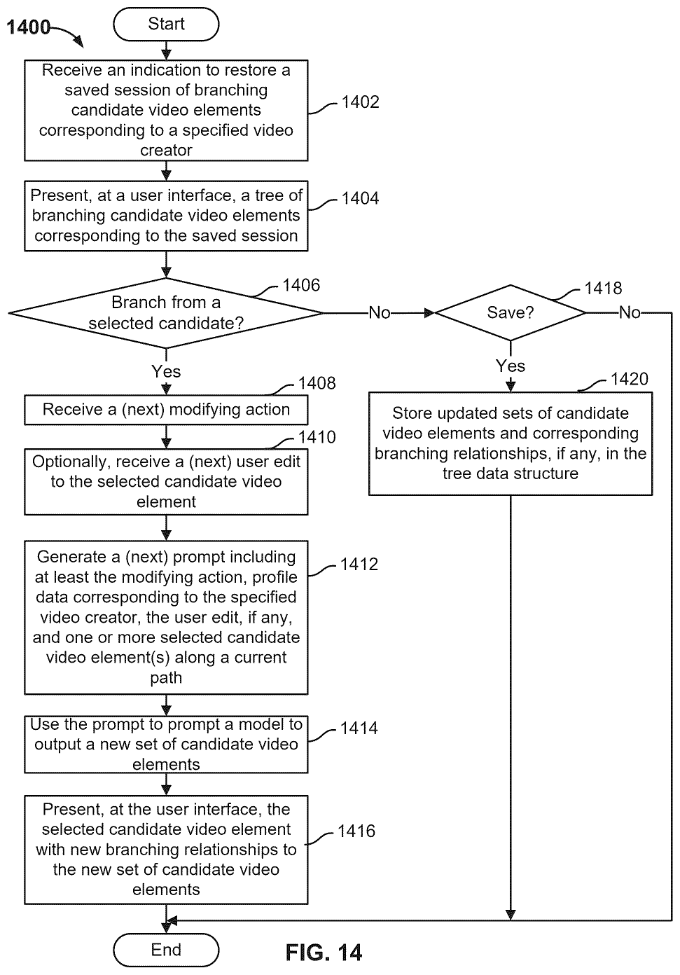

FIG. 14 is a flow diagram showing an example of a process for restoring a saved session in accordance with some embodiments. In some embodiments, process 1400 may be implemented at candidate video element branching system 104 of FIG. 1.

Process 1400 is an example process for restoring a previously saved session of branching candidate video elements for a specified video creator. As will be illustrated in further detail below, the tree-shaped series of branching candidate video elements associated with the restored session are presented at the user interface, at which a user can interact with the user interface to select a previously generated candidate video element within the tree upon which to iterate a new set of candidate video elements.

At 1402, an indication to restore a saved session of branching candidate video elements corresponding to a specified video creator is received. In some embodiments, a session/instance of a candidate video element generation process corresponding to a specified video creator was previously saved at an earlier point in time and is now requested to be restored.

At 1404, a tree of branching candidate video elements corresponding to the saved session is presented at a user interface. A tree-shaped data structure that represents the tree-shaped series of generated sets of candidate video elements that descend from a root node comprising the base data (e.g., such as the example data structure of FIG. 13) associated with the requested session is retrieved from storage and restored by being visualized at a user interface.

At 1406, whether a selection to branch from a selected candidate video element is determined. In the event that the selection to branch from a selected candidate video element is received, control is transferred to 1408. Otherwise, in the event that a selection to branch from a selected candidate video element has not been received, control is transferred to 1418. In various embodiments, additional candidate video elements are to branch from a candidate video element within the restored sets(s) of previously generated sets of candidate video elements when a user selection of one such candidate video element is received via the user interface. For example, if the user wanted to resume iterating to a next batch of candidate video elements to review further options for a future video production from a saved session, then the user can make a selection of any previously generated candidate video element (e.g., in either the most recently generated set or any set generated before that). But if the user did not choose to iterate through to a next batch of candidate video elements, then the user can indicate to close the user interface or to otherwise pause the iterative generation process.

At 1408, a (next) modifying action is received.

At 1410, a (next) user edit to the selected candidate video element is optionally received.

At 1412, a (next) prompt including at least the modifying action, profile data corresponding to the specified video creator, the user edit, if any, and one or more selected candidate video element(s) along a current path is generated. The next prompt may include, in addition to the next modifying action and the profile data of the video creator, at least the most recently selected candidate video title, the optional user edit, and potentially, one or more previously selected candidate video titles within the current path (including the working title). When the base data and each other previously selected candidate video title of the current path are included in the prompt, each value is assigned a corresponding weight (e.g., more recently selected candidate video titles are assigned higher weights than older selected candidate video titles/the working title so as to attribute greater influence to more temporally proximate signals).

At 1414, the prompt is used to prompt a model to output a new set of candidate video elements. The machine learning model corresponds to the candidate video element type for which the session is being restored.

At 1416, the selected candidate video element is presented with new branching relationships to a new set of candidate video titles at the user interface. In some embodiments, the next modifying action is also presented/highlighted at the user interface so as to identify the action that was performed on the most recently selected candidate video element to generate the new set of candidate video elements.

At 1418, whether an indication to save the session has been received is determined. In the event that the indication to save the session has been received, control is transferred to 1420. Otherwise, in the event that the indication to save the session has not been received, process 1400 ends. For example, if the user had caused additional set(s) of candidate video elements to be generated and wants to save the updated state, then the user can submit a selection to save the current state at the user interface.

At 1420, updated set(s) of candidate video elements and corresponding branching relationships, if any, are stored in the tree data structure. The tree-shaped data structure that stores the branching relationships among sets of candidate video elements can be updated to include the additional set(s) of candidate video elements that have been generated since the session was restored.

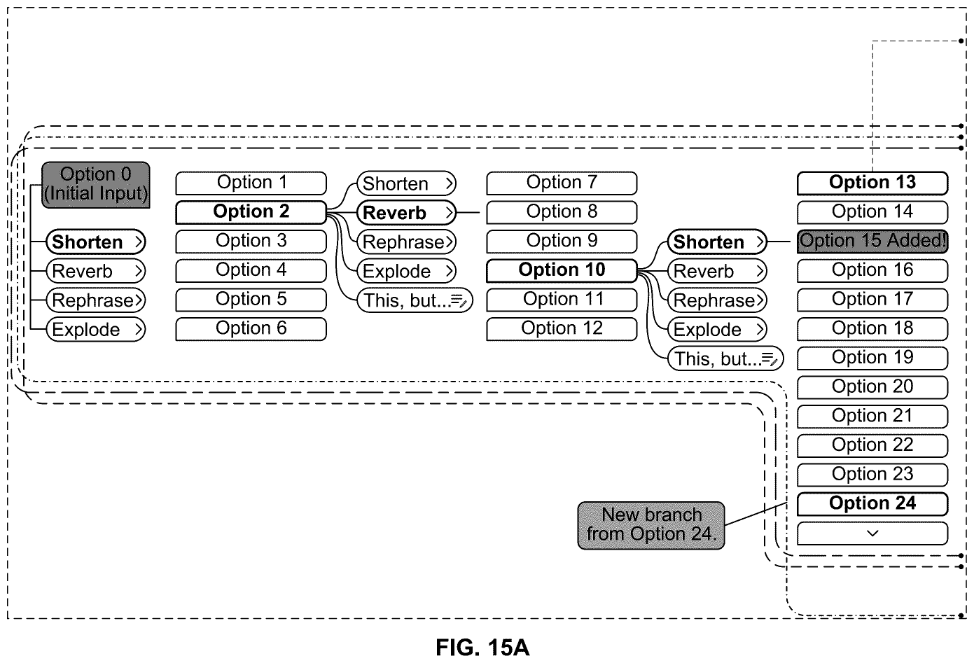

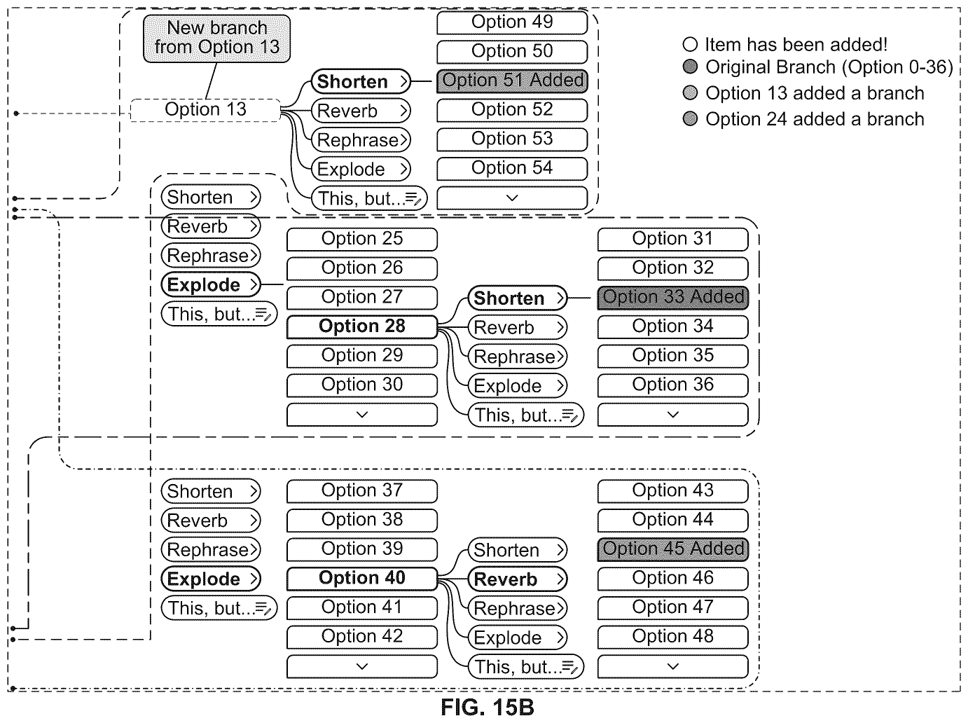

FIG. 15A and 15B are diagrams that represent three different branching trees of candidate video elements. The example illustration across FIGS. 15A and B shows three different trees of candidate video elements where each tree is delineated by a corresponding outline. These three different trees share common base data (e.g., an initial user input, which is denoted as Option 0) as well as the three initial sets of branching candidate video elements (Options 1-36). For example, each tree may have been stored (e.g., as a corresponding separate tree data structure) as a result of the session associated with the base tree portion being restored and then further iterated in three different instances to iterate into different selected paths. Specifically, the three different trees differ in paths as the first tree branches from Option 13, the second tree branches from Option 15, and the third tree branches from Option 24. Each of the trees associated with the different selected paths was then stored as a separate and new tree-shaped data structure. For purposes of illustration, the three different paths that originate from the same base data and share the same first three sets of candidate video elements are depicted across FIGS. 15A and B even though, in practice, the three different trees may be saved as three separate data structures/files. FIGS. 15A and B also illustrate that in some embodiments, a user can add a new candidate video element (e.g., Option 15, Option 33, Option 45, and Option 51) into a set of candidate video elements that were output by a model.

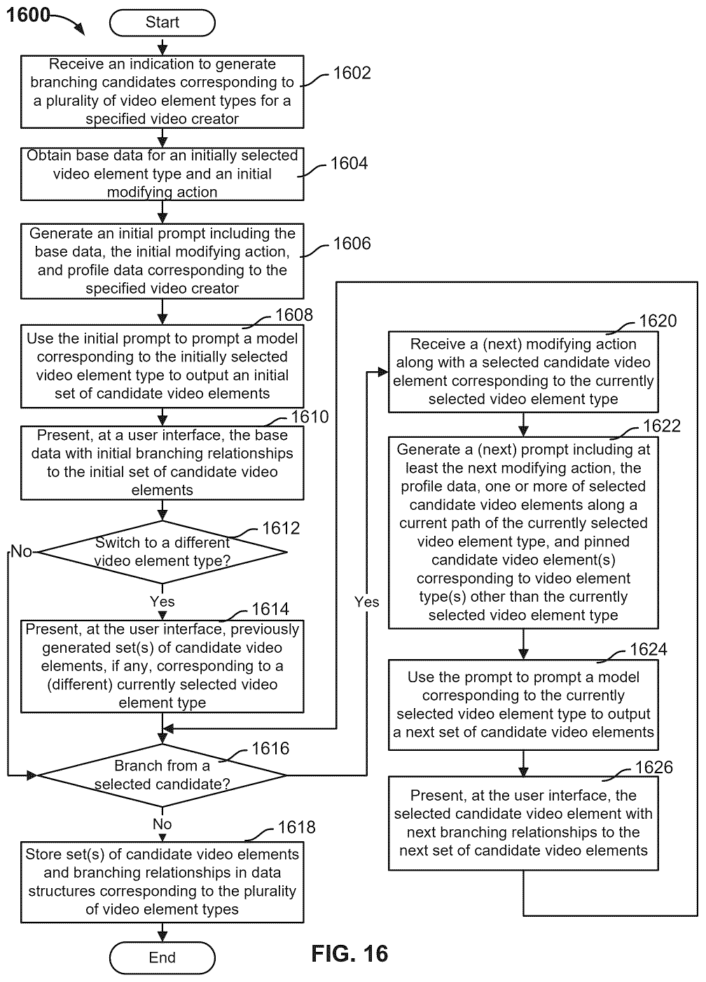

FIG. 16 is a flow diagram showing an example of a process for generating candidate video elements corresponding to a plurality of video element types in accordance with some embodiments. In some embodiments, process 1600 may be implemented at candidate video element branching system 104 of FIG. 1. In some embodiments, process 300 of FIG. 3 may be implemented, at least in part, using process 1600.

Process 1600 is an example process for generating candidate video elements corresponding to a plurality of video element types (“multi-modal” operation) for a video creator. Process 1600 can be used to iteratively generate and visually represent sets of candidate video elements corresponding to two or more types related to a single project in response to user feedback. As will be described in further detail below, in the multi-modal operation, the user can switch among the generation of new candidate video elements corresponding to different video element types, and where the subsequent branching of candidate video elements corresponding to a first element type can be constrained/influenced by a pinned/favorited candidate video element corresponding to a second element type.

At 1602, an indication to generate branching candidates corresponding to a plurality of video element types for a specified video creator is received.

At 1604, base data for an initially selected video element type and an initial modifying action are obtained. In some embodiments, to start the multi-modal operation, the user is to select one of the video element types for which to obtain base data from which to iterate from. For example, if the multi-modal operation includes video element types A, B, and C, then the user is invited by the user interface to select one of A, B, and C for which base data is to be obtained (e.g., via user input or generated at random) and upon which to generate an initial set of candidate video elements.

At 1606, an initial prompt including the base data, the initial modifying action, and profile data corresponding to specified video creator is generated.

At 1608, the initial prompt is used to prompt a model corresponding to the initially selected video element type to output an initial set of candidate video elements. For example, if the multi-modal operation includes video element types A, B, and C and the user had initially selected type A, then the model(s) corresponding to type A are prompted.

At 1610, the base data is presented with initial branching relationships to the initial set of candidate video elements at a user interface.

At 1612, whether branching candidate video elements are to switch to a different video element type is determined. In the event the that branching candidate video elements is to switch to a different video element type, control is transferred to 1614. Otherwise, in the event that the branching candidate video elements is not to switch to a different video element type, control is transferred to 1616. For example, if candidate video elements had been generated for element type A and the user selects to switch to generating candidate video elements corresponding to element type B for the same project, then type A is no longer the currently selected element type and B becomes the currently selected element type until the user switches to another type (e.g., A or C).

At 1614, previously generated sets of candidate video elements, if any, corresponding to a (different) currently selected video element type are presented at the user interface. Any previously generated sets of candidate video elements for the newly selected, different video element type associated with the same multi-modal project are presented (e.g., in their respective tree-shaped form) at the user interface so that the user can interact with the presentation to select a candidate video element therein from which to generate additional candidate video elements.

At 1616, whether additional candidate video elements are to branch from a selected candidate video element of the currently selected video element type is determined. In the event that additional candidate video elements are to branch from a selected candidate video element, control is transferred to 1620. Otherwise, in the event that additional candidate video elements are not to branch from the selected candidate video element, control is transferred to 1618.

At 1618, set(s) of candidate video elements and branching relationships are stored in data structures corresponding to the plurality of video element types.

At 1620, a (next) modifying action along with a selected candidate video element are received.

At 1622, a (next) prompt including at least the next modifying action, the profile data, one or more of selected candidate video elements along a current path of the currently selected video element type, and pinned candidate video element(s) corresponding to video element type(s) other than the currently selected video element type is generated. The next prompt may include, in addition to the next modifying action and the profile data of the video creator, at least the most recently selected candidate video element and potentially, one or more previously selected candidate video elements within the current path (including the base data) of the currently selected video element type, and also pinned/favorited candidate video element types corresponding to the other video element type(s). In multi-modal operation, at any time, at the user interface of the currently selected video element type, not only can the user select a candidate video element upon which to iterate additional candidate video elements, the user can also pin a candidate video element as the current “favorite” candidate for that video element type such that the subsequent generation of candidate video elements for other video element types of the same project is also constrained by the pinned/favorite candidate video element of the currently selected type. For example, the pinned candidate video element corresponding to element type A would be used to constrain the generation of (by being included in a prompt to the corresponding model configured to output the) candidate video elements of either types B or C that are included in the same project. For example, a predetermined template for a prompt to a model in the multi-modal operation would include similar placeholder values that are included in the single mode operation templates but would additionally include placeholder value(s) for pinned/favorited candidate video elements of other video element types. If the pinned candidate video element is a type that is image-based and the prompt to a model is to be in text, then a text-based description of the pinned image can be derived using a vision artificial intelligence model and that text-based description can be included in the prompt.

At 1624, the prompt is used to prompt the model corresponding to the currently selected video element type to output a next set of candidate video elements.

At 1626, the selected candidate video element is presented with next branching relationships to the next set of candidate video elements at the user interface. In some embodiments, the next modifying action is also presented/highlighted at the user interface so as to identify the action that was performed on the most recently selected candidate video element to generate the current/new set of candidate video elements of the currently selected video element type.

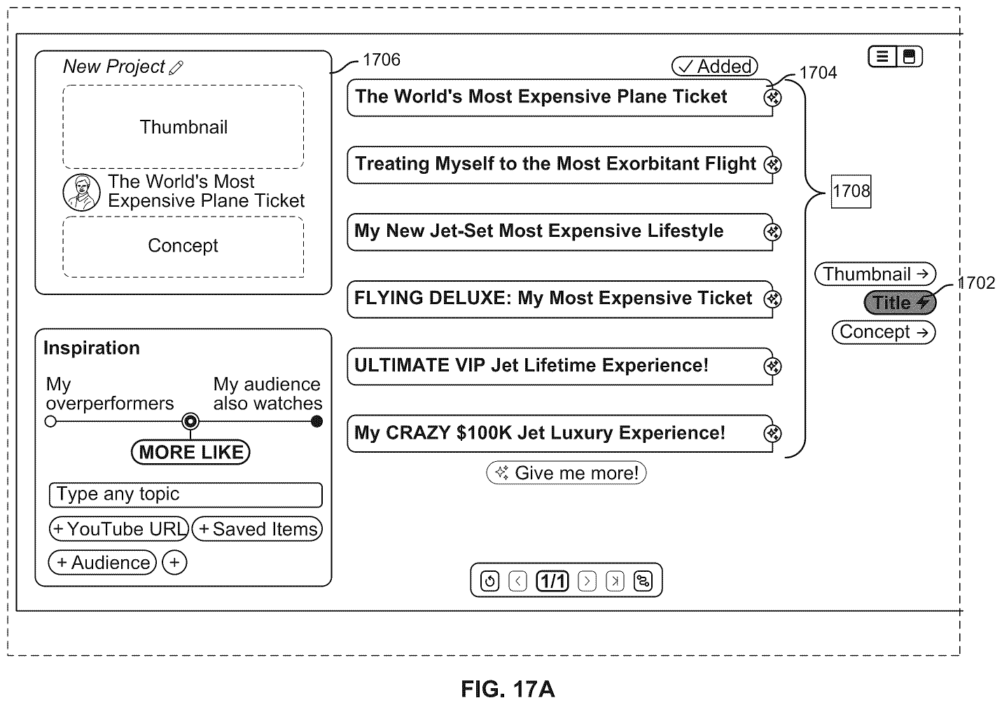

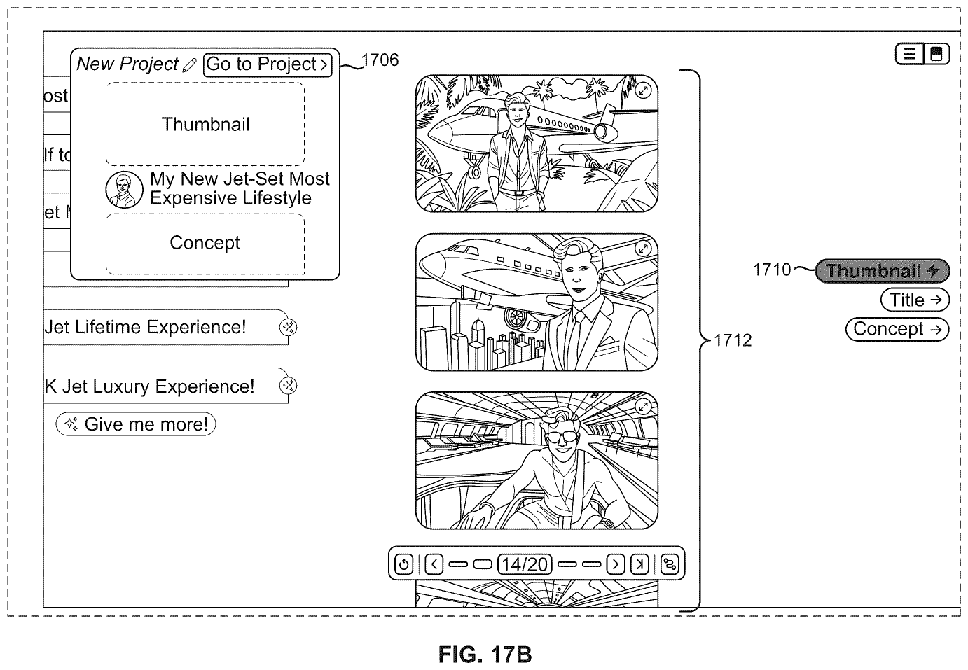

FIGS. 17A and 17B show example user interfaces associated with multiple video element type candidate generation in accordance with some embodiments. In contrast to the examples described above with FIGS. 7 through 11 which illustrate candidate video element generation associated with a single video element type, FIGS. 17A and 17B illustrate candidate video element generation across multiple video element types associated with a single project. As mentioned above, candidate video element generation associated with multiple video element types is referred to as being in “multi-modal” operation. In multi-modal candidate video element generation, in various embodiments, a user can switch among multiple video element types and select to generate candidate video element types of the currently selected type by prompting a corresponding machine learning model with a text description that describes, at least in part, the selected candidate video element of a different video element type. In the example of FIGS. 17A and 17B, the multi-modal operation involves the video element types of thumbnail image, video title, and video concept. For example, in the user interface of FIG. 17A, the user had selected Video Title 1702 as being the currently selected video element type for which to generate candidate video elements. As a result, set of candidate video titles 1708 was generated by prompting a LLM for video title generation (e.g., based on base data that is also provided by the user or output). From set 1708, the user had selected candidate video title 1704 of “The World's Most Expensive Plane Ticket” and this selected candidate video title 1704 will be added to pinned window 1706 associated with “New project” that includes the currently selected/favorited candidates for the three video element types of video thumbnail image, video title, and video concept. In the user interface of FIG. 17B, the user had then switched to Video Thumbnail 1710 as being the currently selected video element type for candidate video element generation. The prompt to a text-to-image model that has been trained to generate images with the attributes (e.g., style, format, dimensions) of video thumbnail images includes a constraint to generate set of candidate thumbnail images 1712 that corresponds to the pinned/favorited candidate video title 1704 of “The World's Most Expensive Plane Ticket.” If the user selects one of set of candidate thumbnail images 1712, then that image would be added to pinned window 1706 associated with “New project” and subsequent candidate video elements of either of the other video element types (Video Title or Video Concept) would be generated by prompting a corresponding model with a constraint comprising a text-based description of the selected candidate thumbnail image. In this way, the user can toggle among the iterations of different video element types that are associated with the same project but the user's pinned/favorited selections of candidate video elements from one or more different video element types can constrain the subsequent iterations of new candidate video elements for the same project.

As described above, in various embodiments, machine learning models (e.g., LLMs and/or diffusion models) can be leveraged to output diverse/creative outputs but that are controlled to conform to the historical attributes of a video creator's videos that have been historically uploaded to a video platform server. Furthermore, the prompting of the models can be programmatically performed and in a manner that is transparent to a user. The series of outputs by the models can be presented in a visually informative manner at a user interface, at which the user can provide feedback in the form of user interactions that will be used to shape/constrain the subsequent prompting of the models to provide continuous iterations of new candidate video elements.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors are configured to:
obtain a first set of candidate video elements from a model by prompting the model using a first prompt including at least base data, a first modifying action, and video creator-specific information;
cause the base data and the first set of candidate video elements to be presented with first branching relationships at a user interface;
receive, via the user interface, a selected candidate video element from the first set of candidate video elements and a second modifying action;
obtain a second set of candidate video elements from the model by prompting the model using a second prompt including at least the selected candidate video element, the second modifying action, and the video creator-specific information; and
cause the selected candidate video element and the second set of candidate video elements to be presented with second branching relationships at the user interface; and
a database configured to store a data structure comprising hierarchical data that describes branching relationships among at least the base data, the first set of candidate video elements, and the second set of candidate video elements.

2. The system of claim 1, wherein the video creator-specific information comprises at least one of profile data associated with a specified video creator and data derived from a set of representative videos associated with the specified video creator.

3. The system of claim 2, wherein the one or more processors are further configured to generate the data derived from the set of representative videos, including to:
identify the set of representative videos corresponding to the specified video creator;
obtain a set of text transcripts corresponding to the set of representative videos; and
derive a set of video summaries by inputting the set of text transcripts into a model configured to output text summaries.

4. The system of claim 1, wherein the one or more processors are further configured to:
receive a text-based description or context corresponding to the base data; and
include the text-based description or the context into the first prompt.

5. The system of claim 1, wherein the model comprises a large language model (LLM).

6. The system of claim 1, wherein the model comprises a large language model (LLM) in series with a text-to-image image model.

7. The system of claim 1, wherein the first modifying action comprises a static modifying action, wherein the static modifying action is predetermined, presented at, and user selected at the user interface.

8. The system of claim 1, wherein the first modifying action comprises a user interactive modifying action, wherein the user interactive modifying action is dynamically user input at the user interface.

9. The system of claim 1, wherein the one or more processors are further configured to:
receive a user edit to the selected candidate video element, wherein the second prompt further includes the user edited selected candidate video element.

10. The system of claim 1, wherein the second prompt further includes the base data, a first weight corresponding to the base data, and a second weight corresponding to the selected candidate video element.

11. The system of claim 1, wherein the first set of candidate video elements comprises a set of text-based candidate video elements.

12. The system of claim 1, wherein the first set of candidate video elements comprises a set of image-based candidate video elements.

13. The system of claim 1, wherein the one or more processors are further configured to:
receive a first indication to store a session of branching candidate video element generation corresponding to the data structure;
receive an indication to restore the session corresponding to the data structure; and
present, at the user interface, the hierarchical data included in the data structure describing the branching relationships among at least the base data, the first set of candidate video elements, and the second set of candidate video elements.

14. The system of claim 1, wherein the first set of candidate video elements is associated with a first video element type associated with a multi-modal operation, wherein the selected candidate video element comprises a first selected candidate video element, and wherein the one or more processors are further configured to:
receive an indication to pin the first selected candidate video element as a pinned candidate video element corresponding to the first video element type;
receive an indication to switch to a second video element type associated with the multi-modal operation;
present, at the user interface, a previously generated set of candidate video elements corresponding to the second video element type; and
receive a third modifying action along with a second selected candidate video element from the previously generated set of candidate video elements corresponding to the second video element type.

15. The system of claim 14, wherein the model comprises a first model, and wherein the one or more processors are further configured to:
obtain a third set of candidate video elements from a second model by prompting the second model using a third prompt including at least the second selected candidate video element, the third modifying action, the pinned candidate video element corresponding to the first video element type, and the video creator-specific information, wherein the second model corresponds to the second video element type; and
present the third set of candidate video elements at the user interface.

16. A method, comprising:
obtaining a first set of candidate video elements from a model by prompting the model using a first prompt including at least base data, a first modifying action, and video creator-specific information;
causing the base data and the first set of candidate video elements to be presented with first branching relationships at a user interface;
receiving, via the user interface, a selected candidate video element from the first set of candidate video elements and a second modifying action;
obtaining a second set of candidate video elements from the model by prompting the model using a second prompt including at least the selected candidate video element, the second modifying action, and the video creator-specific information; and
causing the selected candidate video element and the second set of candidate video elements to be presented with second branching relationships at the user interface,
wherein a data structure comprising hierarchical data that describes branching relationships among at least the base data, the first set of candidate video elements, and the second set of candidate video elements is stored at a database.

17. The method of claim 16, wherein the video creator-specific information comprises at least one of profile data associated with a specified video creator and data derived from a set of representative videos associated with the specified video creator.

18. The method of claim 17, further comprising generating the data derived from the set of representative videos, including:
identifying the set of representative videos corresponding to the specified video creator;
obtaining a set of text transcripts corresponding to the set of representative videos; and
deriving a set of video summaries by inputting the set of text transcripts into a model configured to output text summaries.

19. The method of claim 16, further comprising:
receiving a text-based description or context corresponding to the base data; and
including the text-based description or the context into the first prompt.

20. The method of claim 16, further comprising:
receiving a user edit to the selected candidate video element, wherein the second prompt further includes the user edited selected candidate video element.
